(19) United States
(12) Patent Application Publication
(10) Pub. No.: US 2006/0089824 A1
(43) Pub. Date: Apr. 27, 2006

(54) Methods and systems for drug screening and computational modeling

(76) Inventors: Peter Siekmeier, Cambridge, MA (US); Steven Matthysse, Road Sudbury, MA (US)

Correspondence Address: FISH & RICHARDSON PC, P.O. BOX 1022, MINNEAPOLIS, MN, 55440-1022, US

(21) Appl. No.: 10/515,458

(22) PCT Filed: May 30, 2003
(86) PCT No.: PCT/US03/17316

§ 371 Date: Sep. 13, 2005

Related U.S. Application Data
(60) Provisional application No. 60/385,292, filed on May 30, 2002.

(51) Int. Cl. G06G 7/48; G06G 7/58

(52) U.S. Cl. 703/11

(57) ABSTRACT

A method for screening a test compound for potential efficacy in treatment of a disorder includes creating a first computer model representative of a volume of disease-afflicted neural tissue exposed to the test compound; and providing an initial excitation to the first computer model. Following a selected computation interval, a first outcome is determined. The first outcome indicates a response of the first computer model to the initial excitation and indicates whether the test compound has the potential to be effective in treating the disorder.

### RELATED APPLICATIONS

This application claims the benefit of the May 30, 2002 filing date of U.S. Provisional Application Ser. No. 60/385,292, the contents of which are herein incorporated by reference.

### FIELD OF THE INVENTION

This invention relates to methods and systems for screening potential medications and compounds using computational network models. The computational network model can be used as a modern drug discovery tool for a variety of medical disorders.

### BACKGROUND OF THE INVETION

The human brain is made up of neurons connected to one another in a complex network. It is believed that when humans learn, new connections are made or existing ones are modified. Neural networks, used in artificial intelligence (A.I.) applications, are massively parallel computing models inspired by the human brain. Such networks are typically implemented by multiple processors connected by adaptive weights. Computational neural models based on such neural networks can simulate brain conditions and provide valuable information and insight about the human brain.

Doctors who treat patients having neuropsychiatric disorders often rely on psychiatric drugs. Specific treatments and drugs exist for specific diagnostic categories of patients. For example, neuroleptics are prescribed for schizophrenia, antidepressants are administered for depression, anxiolytics for anxiety, lithium for mania, and stimulants, such as RITALIN®, for attention-deficit hyperactivity.

Before prescribing drugs to humans, it is prudent to first test them to ensure that they are effective, or at the very least, that they are safe. The most straightforward way to test such drugs is to test them on humans. As late as the middle of the last century, for example, it was routine to test drugs on prisoners and on patients in mental asylums. In fact, the well-known antipsychotic drug chlorpromazine was discovered in this way.

Since then, it has become unethical to test new drugs in this way. As a result, the safety and efficacy of new drugs is assessed by testing them on animal models. In the case of psychiatric drugs, this generally involves isolating an animal behavior that is thought to be analogous to a human behavior or psychiatric condition, administering the drug in question to the animal, and observing if the behavior changes. As an example, the operant conflict test in rats is thought to embody behavior analogous to anxiety in humans, and the medication DIAZEPAM®, also known as VALIUM®, was discovered by its ability to decrease such behavior in rats in a laboratory environment.

However, not all psychiatric disorders and neuropsychiatric conditions have clear behavioral correlates in animals. For certain neuropsychiatric brain disorders, such as schizophrenia, it is difficult to test the efficacy of a potential drug preclinically, in part because there are presently no well-established animal models of schizophrenia As a result, using animal models to sdreen antipsychotic medications for antischizophrenic potency is not feasible. Thus, for conventional antipsychotic medications or neuroleptics, and for many neurological disorders, there are currently no well-understood and established methods for preclinically screening potential drugs safely and expeditiously.

### SUMMARY

The invention features screening test compounds for their efficacy in the treatment of various types of medical, e.g. neural disorders prior to human clinical trials. Such neural disorders can include, for example, brain disorders manifested as psychiatric disorders, or other disorders, for example disorders of the myenteric plexus, that are susceptible to neurocomputational modeling.

In one aspect, the invention includes a method for screening a test compound for potential efficacy in treatment of a disorder by creating a first computer model representative of a volume of disease-afflicted neural tissue exposed to the test compound and then providing an initial excitation to that first computer model. A first outcome is then determined. This first outcome is indicative of a response of the first computer model to the initial excitation, which also represents the potential efficacy of the test compound at treating the disorder.

One practice of the invention includes creating a second computer model representative of the volume of disease-afflicted neural tissue. This volume is not exposed to the test compound. An initial excitation is then applied to this second computer model to produce a second outcome indicative of a response of the second computer model to the initial excitation. A difference between the first and second outcomes indicates that the test compound is a candidate compound for treating the disorder.

In another practice of the invention, a third computer model representing a volume of neural tissue free of the disease is created and provided with an initial excitation to produce a third outcome indicative of a response of the third computer model to the initial excitation. A similarity between the first and third outcomes indicates that the test compound is a candidate compound for treating the disorder.

In another aspect, the invention includes a system for screening a test compound. The system includes a processor and a memory coupled to the processor. Encoded in the memory is software that, when executed, causes the processor to generate a computational network model manifesting a neuropsychiatric or neurological disorder, to apply physiological data of the test compound to the computational network model; and to determine, based on the application of the physiological data to the network model of the neuropsychiatric or neurological disorder, the efficacy of the test compound for treatment of the disorder.

Yet another aspect includes a computer-readable medium on which is encoded a data structure representative of a biologically-realistic model of a volume of hippocampal tissue. The data structure includes data representative of population of neurons in each layer of the hippocampus, data representative of types of neurons in each layer of the hippocampus; and data representative of synaptic connections between neurons in the hippocampus.

In another aspect of the invention, a computational network model of the disorder is generated. Based on existing or newly-derived physiological data about the test compound, e.g., a test drug compound, being screened, the data is applied to the computational network model of the brain disorder to determine if the results of the computer simulation are favorable for the treatment of the brain disorder. As used herein, “favorable” means that the computer simulation, i.e., the computational model of the brain disorder shows signs of physiological improvement consistent with improvements in the brain disorder. After the test compound data has been applied to the network model, and if the results are favorable, the test compound is identified as a viable candidate drug for treatment of this particular brain disorder.

According to one aspect, the invention features a computational method for determining whether a test compound is a candidate drug compound for treating a medical disorder by generating a computational network model of the medical disorder, applying physiological data of the test compound to the computational network model, and determining the efficacy of the test compound for treating the medical disorder. A favorable outcome in the network model indicates that the test compound is a candidate drug to treat the medical disorder.

One or more of the following features may also be included.

The medical disorder is a neuropsychiatric or neurological disorder. In certain embodiments, generating the computational network model for the neuropsychiatric disorder includes generating a computational network model of the human brain manifesting one or more of normal characteristics of human behavior, and introducing digital representations of one or more physiological lesions to that computational network model consistent with suspected neuropathology of the neuropsychiatric or neurological disorder.

In another embodiment, generating the computational network model for the neuropsychiatric disorder includes generating a network representing biological characteristics of human brain physiology and generating a computational network model that mimics the in vivo brain neuronal circuitry.

In yet another embodiment, the computational method also includes adding functional characteristics to the computational network model to generate a model of the medical disorder by degrading neurons of the computational network model in a manner analogous to the degradation of neurons in humans afflicted with the neuropsychiatric or neurological disorder.

In another embodiment, applying the physiological data of the test compound includes modeling effects of the test compound on neuronal ion channels. Further, modeling the effects of the test compound includes simulating the computational network model with neurotransmitter induced effects. Applying the physiological data of the test compound can also include modeling effects of the test compound on dendritic input integrating for producing an axonal output. Applying the physiological data of the test compound further includes altering how intracellular processes are performed in the computational network model. Applying the physiological data of the test compound can also include affecting neurotransmitter release properties of neurons in the computational network model.

The computational method can also include determining effects on individual neuron behavior experimentally in vivo or in vitro by exposing biological neurons to the test compound and then implementing the experimental findings in the computational network model.

In certain embodiments, determining the efficacy of the test compound for treatment includes determining whether the application of the test compound has modified behaviors attributable to the neuropsychiatric or neurological disorder in a beneficial way.

Embodiments include those in which the neuropsychiatric or neurological disorder is schizophrenia, Alzheimer's disease, dementia, seizure disorder, bipolar disorder, or obsessive compulsive disorder.

In another embodiment, the computational method includes implementing the computational network model using simulation software. The simulation software can, but need not be, based on an attractor network model.

In another aspect, the invention features a computational method for screening a test compound for a medical disorder. The computation method includes selecting a first computational network model for a psychiatric medical disorder, identifying and applying input data of a test compound to the first network model to obtain measured changes and resulting data in the first network model, comparing the changes and resulting data in the first network model to changes and resulting data in a second network model influenced by a test compound known to be effective for treating the medical disorder, and determining, based on the comparison of the first and second network models, the efficacy of the test compound for medical treatment.

One or more of the following features may also be included.

Embodiments include those in which the medical disorder of the computation method is a neuropsychiatric or neurological disorder. Further, generating the computational network model for the neuropsychiatric disorder includes generating a computational network model manifesting one or more of normal characteristics of human behavior, and introducing structural lesions to that computational network model consistent with suspected neuropathology of the neuropsychiatric or neurological disorder.

In another embodiment, the computational method includes introducing functional lesions to generate a model of the medical disorder by degrading neurons of the computational network model in a manner analogous to the functional degradation of neurons in humans afflicted with the neuropsychiatric or neurological disorder.

In yet another embodiment, applying the physiological data of the test compound includes modeling effects of the test compound on neuronal ion channels. In yet another embodiment, modeling the effects of the test compound includes simulating the computational network model with neurotransmitter induced effects.

In certain embodiments, applying the physiological data of the test compound includes modeling effects of the test compound on dendritic input integrating for producing an axonal output. Further, applying the physiological data of the test compound includes altering how intracellular processes are performed in the computational network model. Moreover, applying the physiological data of the test compound includes affecting neurotransmitter release properties of neurons in the computational network model.

In another embodiment, the computational method includes determining effects on individual neuron behavior experimentally in vivo by exposing neurons of the computational network model to the test to implement the experimental clinical data in the computational network model.

In yet another embodiment, determining the efficacy of the test compound for treatment includes determining whether the application of the test compound has m odified behaviors attributable to the neuropsychiatric or neurological disorder in a beneficial way.

In certain embodiments, the neuropsychiatric or neurological disorder is schizophrenia, Alzheimer's disease, dementia, seizure disorder, bipolar disorder, or obsessive compulsive disorder.

In another embodiment, the computational method includes implementing the computational network model using simulation software. The simulation software can be a general neural simulation system. Examples of suitable simulation software include GENESIS and NEURON.

In yet another aspect of the invention, the invention features a test-compound-screening system that includes a computational network model, a processor, and a memory coupled to the processor. The memory encodes software causing the processor to generate the computational network model manifesting a medical disorder, to apply physiological data of the test compound to the computational network model, and to determine, based on the application of the physiological data to the network model of the disorder, the efficacy of the test compound for treatment of that disorder.

One or more of the following features may also be included.

Embodiments include those in which the medical disorder is a neuropsychiatric or neurological disorder. In another embodiment, the software also cause the processor to generate a computational network model manifesting one or more of normal characteristics of human behavior or of normal tissue behavior, and to introduce physiological lesions that computational network model consistent with suspected neuropathology of the neuropsychiatric or neurological disorder.

In yet another embodiment, the software further cause the processor to add functional characteristics to generate a model of the medical disorder by degrading neurons of the computational network model in a manner analogous to the degradation of neurons in humans afflicted with the neuropsychiatric or neurological disorder.

In yet another embodiment, applying the physiological data of the test compound includes modeling effects of the test compound on neuronal ion channels.

In yet another embodiment, modeling the effects of the test compound includes simulating neurotransmitter-induced effects. Examples of neurotransmitters whose effects can be simulated include dopamine, aceylcholine, and serotonin

The invention provides several advantages.

The computational network modeling based on neural networks for drug screening provides rapid screening of chemical compounds in silico for various psychiatric and neurological disorders, even where no suitable animal models exist.

Furthermore, screening classes of chemical compounds independently from effects on known molecular targets may open new areas of drug screening by identifying classes of drugs that do not act through any known molecular target.

The present computational network modeling systems and methods can be used, for example, by pharmaceutical and biotechnology companies, as part of a comprehensive drug discovery and development process, as well as by academic and other laboratories studying different pharmacological aspects of neuropsychiatric drugs. The new systems and methods of the present invention can be used, alone or in combination, with existing methods, to improve the accuracy of the drug screening processes in the screening of drug compounds prior to clinical trials. As a result, drug compounds with a likelihood of clinical effectiveness can be readily and quickly identified. This would increase the number of drugs, medications, and agents screened while at the same time decreasing the overall costs of the screening process. Further, drugs and medications that are more effective than currently available drugs can be made safely available for treatment.

The computational network models also provide the ability to model multiple pathways or multiple molecular targets in a single assay. Additionally, the computational models provide the ability to assess test compounds based on their physiological, rather than biochemical, properties.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conffict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

FIG. 1 is a schematic diagram for testing a computational network model hypothesis.

FIG. 2 is a schematic representation of a two-memory state for a nine-unit attractor Hopfield network.

FIG. 3 is a schematic representation of an energy landscape of an attractor Hopfield network.

FIG. 4 is a schematic representation of a computational network model with three attractors.

FIG. 5 is a detailed flow diagram of the computational drug screening or discovery process.

FIG. 6 is a flow diagram for generating a computational network model of a disorder in the computational drug screening process of FIG. 6.

FIG. 7 is a flow diagram for applying potential drug effects to the computational model of FIG. 6.

FIG. 8 is a diagram model parameters that can be changed for simulating the effect of a drug.

FIG. 9 is a flow diagram of another computational drug screening or discovery process.

FIG. 10 is a computer system used to carry out the computational test screening process of FIG. 2.

FIG. 11 is a software module used in the computer system of FIG. 10.

FIG. 12 is a graph indicating axonal and dendritic arborizations of intemeuron species.

FIGS. 13A and 13B are graphs comparing modeled and measured spike rates for pyramidal cells.

FIGS. 13C and 13D are graphs comparing modeled and measured spike rates for intemeurons.

FIGS. 14A and 14B are graphs comparing modeled and measured inter-spike intervals for pyramidal cells.

FIGS. 14C and 14D are graphs comparing modeled and measured inter-spike intervals for intemeurons.

FIG. 15A is a graph of the output of a virtual electrode in a model of a normal hippocampus.

FIG. 15B is a graph of a firing pattern of neurons from a model of a normal hippocampus.

FIG. 16 is a graph of a neuron firing pattern from a model of a hippocampus with I_{AHP} channels removed.

FIG. 17 is a graph of neuron firing patterns from a model of a schizophrenic hippocampus.

FIG. 18 is a graph of neuron firing patterns from the hippocampus model of FIG. 17 after having been treated with a psychiatric drug.

### DETAILED DESCRIPTION

The new drug screening computational network model enables the identification of compounds having desired pharmacological effects on medical disorders. The methods and systems provide valuable information and research and development support for pharmaceutical and other companies by enabling screening of test compounds in silico for medical disorders, including those lacking adequate animal models. Therefore, the new methods and systems provide an adjunct to high-throughput screening (HTS) methods and other tools of modem drug discovery for various types of medical disorders, e.g., neuropsychiatric disorders such as schizophrenia.

First, the overall systems and methods of screening test compounds are described. In later sections, the details of individual steps and elements of the new systems and methods are presented. Then, representative examples are set forth.

General Methodology

The new methods and systems include modeling, on a computer, the effects that different chemical compounds (e.g., drugs) or biological factors have on specific neural disorders. When applied to disorders for which no appropriate animal model exists, the new methods and systems of computer-based drug modeling can identify the molecules to which further chemistry, rational drug design, in silico computer-aided drug design, or HTS methods can be applied.

For example, in the case of disorders for which a model can be constructed, medication effects can be applied at the level of single cells. This is generally done by shifting the model parameters that control the neurophysiologic behavior of the model's constituent neurons. Such model parameters include those representing ion channel or synaptic density. The effects of these changes on the overall behavior of the network can then be observed. The computational network model thus translates the effects of a drug on individual neurons into the effects of the drug on a biological system made up of many neurons.

In its most general sense, a computational network model includes a number of interconnected neurons whose emergent, collective behavior is intended to emulate that of a biological system. The network cellular level parameters present in a network model and measured in a biological system can be of any type. Neural models range in complexity from simple “computational units” that sum a weighted vector of inputs to produce and output, to complex compartmental models that take into account time-varying conductances and Hodgkin-Huxley ion channels. In no case are all underlying neurobiological variables and mechanisms known. Consequently, it is often necessary to begin with a hypothesis to explain an unknown mechanism. This hypothesis is then refined as more experimental data becomes available.

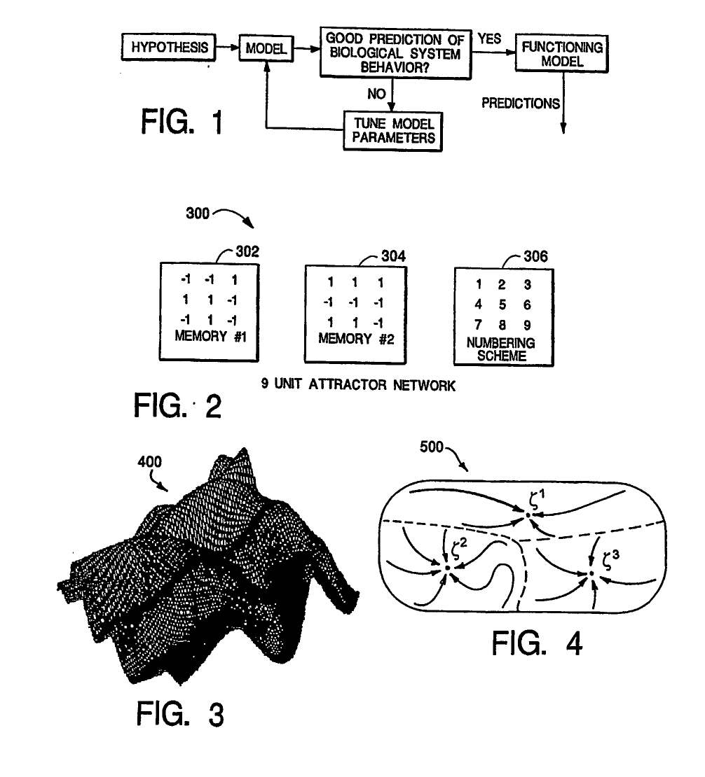

The development and testing of a computational model for simulating a biological system is by nature an iterative process. Referring to FIG. 1, that process begins with the formulation of a hypothesis (step 102) and the construction of a network model (step 104) embodying that hypothesis. The assumptions about the behavior of the biological system that underlie the hypothesis are embodied in the equations and the parameters of the model and generally implemented on a computer.

Execution of the model (step 104) results in an output 106 that attempts to simulate the behavior of a biological system. This output 106 is then quantitatively compared with corresponding experimentally observed values obtained from the actual biological system (step 108) to determine how well the output (step 106) matches the corresponding observed values from the biological system. If the difference or mismatch is below some threshold, the model is considered suitable for use in making predictions about the behavior of the biological system (step 110). Otherwise, the parameters of the model are tuned (step 109) and the model is re-executed using the new model parameters (step 104). This process continues until model outputs are within reasonable agreement with experimental values.

Neural Networks

Neuro-computational modeling has been developed to solve problems ranging from natural language understanding to visual processing and behavior prediction. A neural network is a computational network model composed of neurons (also known as nodes, units, or perceptrons) and connections between the neurons. The strength of each connection is expressed by a weight. The activation of a given node is based on the activations of the nodes that have connections directed at that node and the weights associated with those connections.

In contrast to conventional computers, which are programmed to perform specific tasks, most neural networks do not follow rigidly programmed rules. Instead, they are “taught” or “trained.” Generally, feed-forward neural networks can be implemented as functions y(f,w) of a vector f of inputs and a weight, or network cellular level parameter vector, w. The weight vector is modified such that the neural network optimally estimates some quantity that depends on f. The process of adjusting weight w is commonly referred to as “training.” Methods for training are referred to as training algorithms.

Most neural network training involves the use of an error function. The weight vector is adjusted to minimize the sum of the averages of the error function on a set of training samples. A penalty term is generally applied to the error to restrict the weight vector in some manner that is thought desirable. Given a desired objective function, various training methods are used to minimize the error. These typically involve the use of some form of gradient descent. For example, in pattern recognition or image analysis, an image (e.g., X-ray) introduced to a neural network for identification, will activate the relevant nodes for producing the correct answer based on its training. Connections between individual nodes are “strengthened” (resistance turned down) when a task is performed correctly and “weakened” (resistance turned up) if performed incorrectly. In this manner, a computational neural network is trained to provide a more accurate output with each repetition of a task.

Computer-based neural network simulation, which was originally inspired by artificial intelligence (A.I.) research, has been used to study human cognition, including psychiatric and neurological mental disorders. Computational network models to study human cognition have been modified to better emulate the dynamic nature of human cognitive processes. Accordingly, neural network models are formulated to capture the emergent properties of assemblies of neurons functioning together. As will be described further below, computational network models can be used to study normal and pathological human brain finctions. Therefore, by using neural network simulation, human thought processes can be modeled by applying principles governing the dynamic interactions within neural ensembles to gain a better understanding of their gross behavior viewed as a cognitive process.

Hopfield (Attractor) Networks

There are a wide variety of neural network architectures. The back-propagation network is described in terms of input information that flows through the system to produce a correct or incorrect output. This network is a system taught to recognize and classify patterns. The Hopfield network, also known as the “attractor” network, is also designed to identify patterns. However, the Hopfield network differs from the back-propagation model in its assumptions about network connectivity, learning rules, and, more broadly, how thoughts are represented in the system.

The Hopfield network is generally conceptualized as an array of neurons, with each neuron connected to every other. Each neuron, as described above, calculates the weighted sum of its inputs and applies a transfer function to determine whether the neuron will be active or inactive. A “memory” consists of a pattern of activation of the constituent neurons. One teaches the network by activating the neurons of a particular memory and then applying a Hebbian Learning rule (i.e., intemeuronal synaptic connections are not static, but can rather vary in strength, depending on the past activity of the constituent neurons), which adjusts the weighting of the inter-neuronal connections. A well-taught network, when presented with a fragment of a memory, will return the complete, intact memory. The examples presented herein are implemented using a Hopfield network.

Hopfield networks have three interrelated properties: (1) memories are stored in a content addressable manner; (2) they are represented in a distributed, rather than localized, form; and (3) the systems are capable of generalization. These characteristics capture the essential ways that attractor networks mirror actual neurobiological processes.

In a content-addressable system, the memory does not “exist” in any particular location, but is spread over several processing units. For example, humans are able to recall items from memory based on a partial description of their contents, and can even do so if the description is not entirely correct. In such a system, referred to as a “content addressable system,” a fragment of a memory provides access to the complete, stored memory. In contrast to the manner in which computers assign each memory to a particular location, artificial neural networks have the ability to recall complete patterns from fragmentary input stimuli.

In a distributed representation, several neurons are involved in the storage of a given memory, and a particular neuron will often be part of the brain's representation of several distinct memories. In part for this reason, removal of one or a small number of neurons from a neural network does not excise a particular memory, nor does it cause a significant decline in overall performance.

In a generalized system, if a network learns new information about an item, that new information is also applied to similar memories stored in the network. This is because memories are distributed among nodes of the network. Hence, two similar memories may have a large number of activated nodes in common; that is, their patterns of activation will overlap.

For example, referring to FIG. 2, in a Hopfield network 300, nine neurons are arranged in a 3×3 array, with each neuron reciprocally connected to every other. In a given cycle, each neuron adjusts its internal state based on the inputs from the other eight neurons in the network 300. The activation state of each neuron will be designated μᵢ. An active neuron is represented as +1 and an inactive neuron as −1. In FIG. 2, two memory states 302 and 304 to be stored are shown.

The synaptic strength of the axonal connection from neuron i to neuron j, designated as T_{i→j}, measures the effect of neuron i on neuron j. This synaptic strength can be positive (excitatory), negative (inhibitory), or 0 (i.e., no axonal connection). The overall effect on neuron j from all other neurons in the system, designated Sⱼ below, is given by:

$${S}_{j} = {\sum }_{i = 1}^{9} {T}_{i - j} \times {μ}_{i} , \qquad i \neq j .$$

If this sum positive, the neuron is activated (i.e., set to +1); if it is negative the neuron is rendered inactive (i.e., set to −1). For a given cycle, the activation state of each neuron in the system is calculated in this way.

The first step in implementing an attractor network is to store memories. This is done by examining each pair of neurons in the system. For instance, if, for a given memory, the activation states of two neurons are the same (i.e., +1 and +1, or −1 and −1), the synaptic strength between them is increased. If they are different (+1 and −1), the synaptic strength between them is decreased. This is carried out for all neurons, across all memories. Mathematically, with Mmemories, this can be represented by a weight T:

$${T}_{i - j} = {\sum }_{m = 1}^{M} {μ}_{i}^{m} \times {μ}_{j}^{m} ,$$

If two neurons in the system are both active (or both inactive) in several memories, the weight T connecting them is large. Conversely, if the activation levels of two particular neurons are different, the weight T is negative. Once the neural network has been trained, the set of weights associated with the network, i.e., the weight matrix, represents the learning of the network. With the formulation given here, the number of memories a network remembers is approximately 0.15 times the number of neurons in the system.

For memories 302 and 304 of FIG. 2, the inter-neuronal weights for the first few combinations is as follows:
T₁₋₁=(−1×−1)+(1×1)=2
T₂₋₁=(−1×−1)+(1×1)=2
T₃₋₁=(1×−1)+(1×1)=0
T₄₋₁=(1×−1)+(−1×1)=−2

This calculation is carried out for all 9×9 neuronal connections. The learning rule results in symmetric weights: T_{i→j}=T_{j→i}.

To test the performance of a network after leaming, a fragment of one of the stored memories is supplied to the network. For example, the top three neurons of a start-up array can match those of memory 302:

−1−1 1

0 0 0

0 0 0

Next the weighted input to each neuron in the system is computed based on this startup array. For neuron 1, S would be calculated as follows:

$$\begin{matrix}{S}_{1} = ( {T}_{11} \times {μ}_{1} ) + ( {T}_{21} \times {μ}_{2} ) + ( {T}_{31} \times {μ}_{3} ) + … \\ = ( 2 \times - 1 ) + ( 2 \times - 1 ) + ( 0 \times 1 ) + … \\ = - 4\end{matrix}$$

Performing the above computation for each neuron in the system yields the following set of Sⱼs:
S₁ S₂ S₃ −4 −3 2
S₄ S₅ S₆ =4 4 −2
S₇ S₈ S₉ −4 2 −2

Applying threshold functions (if Sⱼ>0, neuron j is on, otherwise, neuron j is off), the following pattern emerges:

−1 −1 1

1 1 −1

−1 1 −1

In Hopfield networks, an energy function is defined as follows:

$$E = - \frac{1}{2} {\sum }_{i = 1}^{N} {\sum }_{j = 1}^{N} {T}_{ij} {μ}_{i} {μ}_{j}$$

Referring to FIG. 3, the energy function can be viewed as an energy landscape 400 having an energy level (z axis) and a network state-space (the x-y plane). The landscape 400 includes all 2^{N} possible combinations of the network (where N is the number of neurons in the network). Each of the local minima of the network corresponds to a memory. As the network evolves, i.e., as the activation states of its neurons are cyclically updated, the energy decreases. Thus, as the network goes through successive cycles of updating, the state of the network flows down the valleys of the energy function, analogous to a ball rolling down hill. The network eventually 20 stabilizes at one of these local minima, or “attractors.” Referring to FIG. 4, a schematic 500 of the state-space of a model with three attractors represents a “projection” of the energy landscape onto the x-y plane. The state-space is divided into “basins of attraction.” In a neural network, if the memory cue is within one of these basins, it is drawn to the indicated memory state.

The change in the energy level of the network due to the change in state of a given neuron μᵢ. (i.e., from −1 to +1, or from +1to −1) is given by:

$$Δ {E}_{i} = - \frac{1}{2} Δ {μ}_{i} {\sum }_{j = 1}^{N} {T}_{ij} {μ}_{i} , \qquad j \neq i$$

Computer Model of Neural Tissue

To prepare a computational model of a neural tissue sample, one first selects a biologically realistic computational model of a single neuron. As used herein, a biologically realistic model of a neuron is one that explicitly models trans-membrane potentials and time-variations thereof.

A suitable model can be obtained by viewing a neuron as having several inputs, corresponding to its dendrites, and a single output, corresponding to its axon. A transfer function, characteristic of the neuron, provides the output as a function of the distribution and timing of inputs. For the purposes of this section, the “transfer function” will refer to the manner in which the dendritic inputs are integrated to produce an output. This is a function of the various species and distribution of ion channels present in the cell as well as its morphology. Such computational models of individual neurons are known in the art. For example, Bower and Beeman, “Book of Genesis: Exploring Realistic Neural Models with the GEneral NEural Simulation System” Springer-Verlag New York Inc., 2d ed. 1998, (hereafter referred to as “Book of Genesis”) provides numerous biologically realistic neuron models based on combining compartments representative of equivalent electrical circuits. Other biologically realistic single-cell models include the active membrane model of the cerebellar Purkinje cell disclosed by De Schutter, et al. “An active membrane model of the cerebellar Purkinje cell: I. Simulation of current clamps in slice,” Journal of Neurophysiology, 71:375-400, and a hippocampal pyramidal cell disclosed by Migliore, et al. “Computer simulations of morphologically reconstructed CA3 hippocampal neurons” Journal of Neurophysiology, 73(3):1157-68, March 1995.

After selecting a model of a single neuron, one then models the transmission of a signal from that neuron to its neighbors. This aspect of the model can include, for example, delays in the output of the neuron, either by modeling a neuron's axon by a series of compartments, or since the signal transmission rate along an axon is relatively constant, by delaying the input to the axon's target by an amount proportional to the distance to that target. This aspect of the model can also include changing the synaptic strength between neurons.

A computational model of a neural tissue sample can then be created by representing the steric relationship between neurons within the sample. This can include representing neuron species present in that sample, and the density of each of those species of neurons within that sample.

Once the steric relationship between neurons has been represented, the next step in constructing a model is to represent patterns of connectivity between neurons. This can include representing how many neurons a particular neuron is connected to and what species those neurons are.

The computational model of neural tissue is made up of a large number of relatively simple independent processors that send messages to each other. The nature of this model lends itself to implementation in an object-oriented environment. In such an environment, the different species of neurons can be represented by different instances of an object class. The transfer functions and other properties of each species of neuron are then encapsulated as methods within the neuron object.

The computational model of neural tissue can be modeled in any object-oriented environment. An example of such an environment is GENESIS (“GEneral NEural Simulation System”). An alternative environment for modeling neural tissue is provided by NEURON. Both GENESIS and NEURON are widely available freeware collections of model building tools that can be executed on typical digital computers using a conventional operating system, such as LINUX.

To model neural tissue having a particular pathology, one alters the defining characteristics of a model of normal neural tissue. For example, one can re-define the manner in which selected neurons communicate with neighboring neurons, either by altering connectivity patterns or synaptic response characteristics. Or, one can re-define the transfer functions associated with selected neurons. In an object-oriented environment, this is done, for example, by changing the corresponding methods encapsulated by the objects.

A psychoactive drug typically finctions by either changing the transfer fimction (e.g. by altering ion channel behaviors) of selected species of neurons or changing the communication characteristics (e.g. by changing synaptic properties) of those neurons. In particular, the transfer function and communication characteristics built into a model of diseased neural tissue can be altered to simulate exposure of that tissue to a psychoactive drug. To determine the manner in which the model is to be altered pharmacologically, one performs in vitro tests of the effect of the drug on individual neurons. Alternatively, if one already knew the effect of a drug on a neuron, one could use that knowledge and bypass the need to perform such in vitro testing.

Once a model has been constructed, an initial excitation is applied to selected neurons. The response of those neurons to the excitation is communicated to neighboring neurons, which in turn communicate their own responses to their own neighbors. This results in a wave of excitations that unfolds over time. The nature of the excitation changes as the neural transfer functions and communications properties change. As a result, when subjected to the same excitation, normal, diseased, and drug-exposed neural tissue provide different outcomes. A comparison of these different outcomes provides a basis for predicting the effect of a particular psychoactive drug on a particular disorder.

For example, one can perturb a model of diseased neural tissue to simulate exposure of that tissue to a drug. The perturbed model and the unperturbed model are then subjected to the same initial stimulus. This results in two outcomes, which will be referred to as the diseased outcome and the treated outcome respectively. If these two outcomes are the same, one can infer that the drug will be ineffective in treating a disorder modeled by the perturbation.

If the treated outcome and the diseased outcome differ, it may be unclear whether the effect of the drug was beneficial or detrimental. In such a case, it is useful to apply the same initial stimulus to a model of normal tissue to obtain a normal outcome. The normal outcome can then be compared with the treated outcome. If the treated outcome is similar to the normal outcome, one can infer that the drug will be beneficial in treating a disease modeled by the perturbation.

Drug Screening

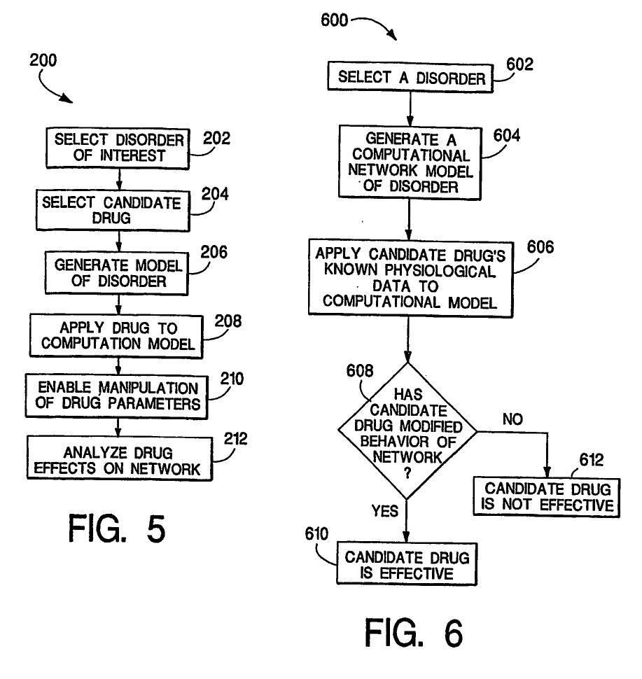

A computational drug screening or discovery process 200, illustrated in FIG. 5, is implemented using the general computational methodology described above. The process 200 includes selecting (step 202) a medical disorder to be studied, e.g., schizophrenia. A known drug compound is selected (step 204) as a test or potential drug compound for the medical disorder. A computational network model, in which rapid screening of test drug compounds, e.g. known medications, can be performed, is generated (step 206). The effects of the test compound are then applied (step 208) to the computational network model thus generated. The effects of the test compound on the network are then analyzed and evaluated (step 212). The new systems and methods of drug screening processes are discussed in greater detail below.

Medical Disorders

Computer-based computational and neural network models provide a basis for studying numerous psychiatric and neuropsychiatric disorders, such as schizophrenia, Alzheimer's disorder, bipolar disorder, seizure disorders, diffuse cerebral atrophy, and obsessive-compulsive disorder, at both microscopic and macroscopic levels. Various medical disorders and mental disorders, such as schizophrenia, Alzheimer's disease, bipolar disorder, and the like, can be modeled using the new computational systems and methods. Accordingly, these computational systems and methods can be used to screen potential drugs for the treatment of any disorder for which behavioral or physiological changes can be modeled in a network model.

Schizophrenia

Schizophrenia is a heritable disorder of the brain resulting from abnormalities thought to result from abnormalities that arise early in life and that disrupt the normal development of the brain. These abnormalities manifest themselves as structural differences between a schizophrenic brain and a healthy brain. For example, schizophrenic brains tend to have larger lateral ventricles and correspondingly smaller volumes of neural tissue than normal brains. It is believed that the chemical nature of a schizophrenic brain, and in particular the manner in which it processes certain neurotransmitters, such as dopamine, is also different.

The effects of endogenous substances, such as dopamine, on normal functioning of the brain have been gathered by assessing how such chemical compounds alter the physiologic functioning of neurons.

Symptomatically, schizophrenia can be characterized by disturbances in the areas of the brain that are associated with thought, perception, attention, motor behavior, and emotion. Schizophrenic symptoms are divided into negative and positive categories. Negative schizophrenic symptoms consist of behavioral deficits such as blunting of emotions, language deficits, and lack of energy. Laboratory data shows that schizophrenics with negative symptoms have reduced brain activity in the prefrontal cortex. Positive schizophrenic symptoms include hallucinations, delusions, and bizarre behavior. Tests performed using positron emission tomography show that during a delusional period (e.g., hearing voices), blood flow is greater than normal in a part of the brain linked to articulated language.

Biochemical factors cause a number of schizophrenic and psychotic symptoms. In particular, excessive production of dopamine is believed to play a role in the chemistry of the schizophrenic brain. Neurotransmitters interacting with certain receptors mediate the transfer of chemical information between neurons. It is thought that when anti-schizophrenic drugs block dopamine receptors in the basal ganglia, the symptoms of schizophrenia are reduced. Five dopamine receptors, D1, D2, D3, D4, and D5, have been discovered. Their function is to bind to dopamine secreted by pre-synaptic nerve cells. This binding triggers changes in the metabolic activity of the postsynaptic nerve cells.

The dopamine receptors involved in the binding processes can be separated into the D1 and D2 families. The Dl family contains the receptors D1 and D5. In the brain, D1 receptors appear to be linked to episodic memory, emotion, and cognition finctions, all of which are disturbed in schizophrenic patients. D1 binding of dopamine is lower in schizophrenic patients than it is in healthy subjects of the same age. The D2 family contains the receptors D2, D3, and D4. D2 is the second most abundant dopamine receptor in the brain. Blockage of D2 family receptors is the main goal of many antipsychotic drugs because there is a higher density of D2 in schizophrenic brains. For example, studies indicate that the density of D4 receptors is elevated six fold in schizophrenic patients.

Dopamine antagonists are drugs that block dopamine receptors. Examples of dopamine antagonists include neuroleptics, such as chlorpromazine (THORAZINE® manufactured by GLAXOSMITHKLINE®). Various studies indicate that controlling dopamine and dopamine receptors helps alleviate symptoms of schizophrenia.

Network Models of Medical Disorders (Schizophrenia)

Referring to FIG. 6, a computational drug screening method 600 includes evaluation of the potential efficacy of a test compound as a psychiatric medications by incorporating that compound's cellular level effects in a computational model of neural tissue having a large number of neurons. This is followed by examination of the emergent “macroscopic” behavior of the tissue. As described previously, given that such models are not exact representations of the human brain, the computational drug screening method 600 identifies test compounds that are likely to be effective in the treatment of schizophrenia, i.e. test compounds that are candidate therapeutic compounds.

The computational drug screening method 600 includes selecting (step 602) a disorder to be studied (e.g., a psychiatric or neurological condition in question such as schizophrenia). A computational network model that manifests the characteristics of, in this case, schizophrenia is generated (step 604).

Once the computational network model has been generated, information about the known effects of the test compound on physiological neurons is incorporated into the constituent computational neurons of the computational network model (step 606). Details of this step are described below in connection with FIG. 8.

The simulated behavior of the psychiatric or neurological condition is then observed to determine if the behavior of the computational network model has been changed for the better (step 608). If the behavior indicative of the disorder has decreased, the test compound is classified as a candidate drug compound (step 610). For example, in a computational network model for schizophrenia, if the network shows fewer instances of “hallucinatory” pattern recognitions, the test compound is classified as a candidate drug compound for treatment of schizophrenia (step 610). Similarly, in a computational network model for Alzheimer's disease, improved memory recall, or a less precipitous decline in memory performance, would indicate that the test compound is potentially an effective treatment of Alzheimer's disease. On the other hand, if no beneficial behavior is observed in the network model, the effectiveness of the test compound cannot be confirmed (step 612).

To generate a computational network model (step 604) manifesting the characteristics of the psychiatric or medical condition in question, existing models can be used or new ones can be created.

For example, one way to construct a computational model for Alzheimer's disease is to modify a model of a healthy brain by deleting neural synapses in a manner consistent with neuroanatomic research findings on the condition of neural tissue in Alzheimer's patients. This results in a computational network model that exhibits a pattern of memory deterioration similar to that seen in patients afflicted with this disease. In other network models, compromised memory recall can be exhibited in a computational network model for this disorder.

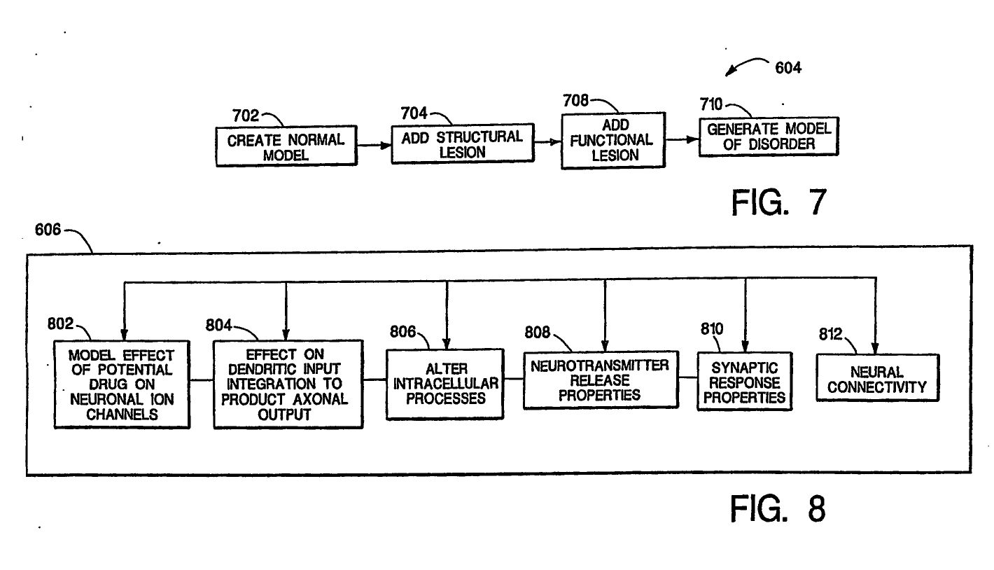

In the case of a schizophrenia model, illustrated in FIG. 7, a network model with “pruned” neuronal connections can be built. The resultant computational network model exhibits pattern recognition behavior suggestive of hallucinations.

In particular, to construct a neural computational network model that can simulate the cognitive functions of a schizophrenic brain, a network model for a normal brain that can perform basic cognitive finctions is first generated (step 702). Then, the network is “lesioned” (step 704) in a manner corresponding to the microanatomic changes seen in actual clinical pathological studies of schizophrenia. For example, the network can be lesioned by removing some of the neurons, or by altering connections between existing neurons.

Additionally, abnormalities that are not structural in nature, but nevertheless affect the functioning of neurons can be applied (step 708). Such “functional lesions” can include, for example, degrading the finctional characteristics of the computer-modeled neurons in ways analogous to what is observed in neurons of humans afflicted with schizophrenia. Other functional lesions include simulating high dopamine levels by, for example, incorporating the effect of dopamine on the manner in which a single computer-modeled neuron integrates signals.

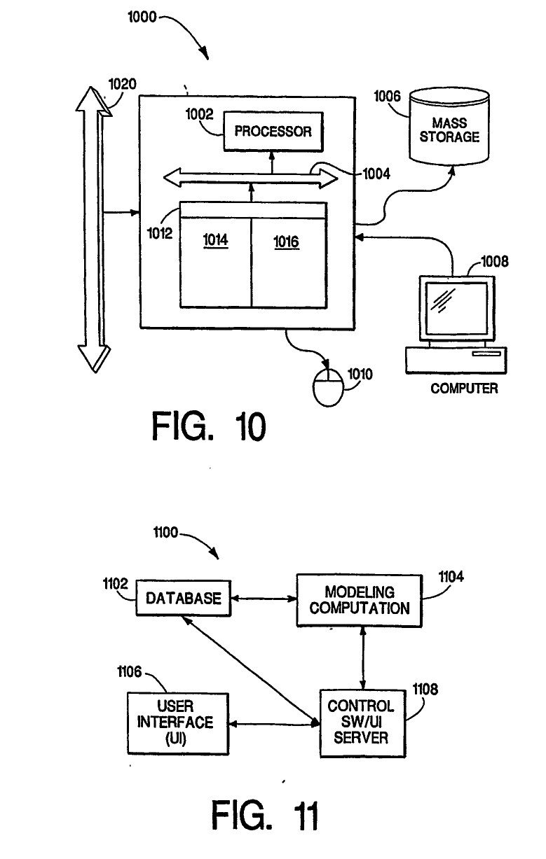

By adding structural and/or functional lesions (steps 704, 708), a computational network model of schizophrenia is generated (step 710). Various computational network models can be implemented as described in greater detail below with reference to FIGS. 10-11.

By applying pathological lesions to a Hopfield computational network model, one can generate a computational network model that manifests the characteristics of schizophrenia (step 604). As described previously, schizophrenia affects a large range of mental activities, adversely impacting functions as diverse as attention, memory, language production, and emotion. Schizophrenia has been associated with many different brain regions, particularly the frontal areas and the hippocampus. Schizophrenia is best understood as a distributed dysfunction in which multiple brain areas pathologically interact with each other.

Although no consensus on the etiology of schizophrenia has been reached, a number of factors are suspected. These include neurodevelopmental dysregulation, excessive dopamine, and various environmental stressors. In step 704 of FIG. 7, one or more pathological lesions are introduced into the computational network model of schizophrenia in a manner consistent with these suspected etiologies.

In neurodevelopmental dysfunction of schizophrenia, excessive cortico-cortical pruning may be a factor. Thus, lesioning (step 704) can be simulated by overpruning of a normal computational network model.

Another way to apply a lesion in step 704 includes incorporating the neuromodulatory effects of dopamine in a network model of a healthy brain, particularly at the level of its impact on the activation finction. For example, one way to mimic the effect of dopamine is: to create an attractor network, for example, one having fifty or more “neurons;” to increase the number of memories stored in the network; and to “overload” the model with dopamine. This results in the development of parasitic attractors in the network. As described previously, the confluence of several energy minima creates a disruptive basin of attraction that attracts toward itself start-up states relatively distant from the constituent cluster of memories. This dysfunctional computational network model exhibits behavior analogous to symptoms of schizophrenia, with the parasitic states representing delusions. Additionally, the computational network model of dopamine has other physiological effects on the schizophrenic network model. These effects include modulation of the level of synaptic noise in the cortex by suppressing spontaneous random firing of neurons.

Another approach to creating a lesioned model is to use an attractor network to create a computational network model of semantic priming, a task that schizophrenics are better at than the normal population. In semantic priming, a subject is exposed to a priming word. The subject is then asked to identify a target word that is semantically related to the priming word. An attractor network is created in which a semantic class is operationalized as particular subset of the neurons of the model. The details of the model are given in Siekmeier and Hoffman,“Enhanced Semantic Priming in Schizophrenia: a Computer Model Based on Excessive Pruning of Local Connections in Association Cortex,” British Journal of Psychiatry, vol. 160:345-350 (2002), the contents of which are herein incorporated by this reference in their entirety.

At baseline, the semantic priming model showed semantic priming behavior similar to that seen in control clinical populations. When this model is lesioned by selectively removing neural connections in way similar to that seen in a schizophrenic brain, the percentage of correctly identified target words increases in a manner consistent with that measured schizophrenic populations. If the priming behavior of such a model, when exposed to a test compound, were to return to baseline, one could infer that the test compound would be potentially effective in alleviating symptoms of schizophrenia.

In most cases, generating a computational network model of schizophrenia includes creating a normal computational network model (step 702) and adding structural or functional lesions to the network model (steps 704, 708) to generate a computational network model of schizophrenia (step 710). Referring back to FIG. 6, once the computational network model of schizophrenia has been generated (step 604), a test compound, e.g. a known compound, is selected and incorporated into the network (step 606) by applying information about its known effects on individual physiological neurons to the model's constituent computational neurons. This can be carried out in a number of ways, as illustrated in FIG. 8. For example, one approach is to model (step 802) the effects of the test compounds on neuronal ion channels or synaptic conductance.

The pre-frontal cortex and its dense dopamine activity are involved in working memory functions. Task-related electrical activity in the pre-frontal cortex is modulated by dopamine, mainly via the Dl receptor, with dopaminergic midbrain neurons activated at the onset of working memory tasks and dopamine levels in the pre-frontal cortex increasing during performance of such tasks. Blockage of dopaminergic input to the pre-frontal cortex or of dopaminergic Dl receptors in the pre-frontal cortex disrupts delay-task performance. Dopamine appears to stabilize actual neural representations in pre-frontal cortex circuits during tasks involved in working memory, thereby rendering them robust against interfering stimuli and noise. Additionally, dopamine shifts the activation threshold of a persistent Na+ current toward hyperpolarized potentials and slows the inactivation process of this current. This appears to contribute to dopamine-induced increases in firing rate and reduced adaptation observed in vitro.

To mimic the dopamine-modulated ionic currents that could give rise to increased stability of neural representations, a network model of the pre-frontal cortex is constructed. The computational network model of the pre-frontal cortex included multicompartment neurons equipped with Hodgkin-Huxley-like channel kinetics that can reproduce in vitro whole cell and in vivo recordings from pre-frontal cortex neurons. Dopaminergic effects on intrinsic ionic and synaptic conductance are implemented in the model based on the in vitro data.

Potential medications and drugs can be introduced into a computational model in a variety of ways. In particular, dopamine-induced shift of the activation threshold can be modeled by altering Na+ conductance in computational pyramidal cells or by reducing K+ conductance. These changes rely on the fact that dopamine decreases slowly inactivating K+ current in prefrontal cortex pyramidal cells, and that dopamine, acting at the D1 receptors, increases N-methyl-D-aspartate (NMDA)-like synaptic currents in the prefrontal cortex. This effect is modeled as an increased synaptic NMDA conductance in the computational neurons. In addition, dopamine effects can be modeled by increasing glycine and g-amino butyric acid (GABA) synaptic conductance based on dopamine induced enhancement of GABAA (GABA, type A)-like synaptic currents in the pre-frontal cortex. Further, based on data that dopamine may heighten spontaneous frning activity of GABA neurons in pre-frontal cortex, the background firing rate (“noise” level) of GABAergic inputs is increased in the computational network model.

Consequently, dopamine strongly enhances high, delay-type activity. The dopamine-induced changes in the biophysical properties of intrinsic ionic and synaptic conductance increase stability of activated representations in pre-frontal cortex networks. Simultaneously, the doparnine-induced changes retain control over network behavior and respond to task-related stimuli.

A second approach for applying the effects of a test compound is to model (step 804) the effect that the test compound is known to have on the integration of dendritic inputs to produce an axonal output, i.e., a “transfer function.” This second method is particularly useful when modeling Hopfield neurons. For example, the effects of a central nervous system stimulant such as methylphenidate (RITALIN®) can be modeled by altering the transfer functions of the network's constituent neurons. Methylphenidate has a notably calming effect on hyperactive children and a “focusing” effect on those with attention deficit disorders. Using this approach (step 804), methylphenidate's ability to enhance responsivity of cells can be modeled as an increase in the gain of those cells'transfer functions.

A third approach is to alter (step 806) model parameters associated with simulation of intracellular processes, such as receptor activation and gene transcription. This method may be useful for modeling the effects of antidepressants. A fourth approach simulates application of a test compound by modeling changes (step 808) in the neurotransmitter release properties of neurons in the network model. A fifth approach simulates application of a test compound by changing (step 810) the synaptic response properties of neurons in the network model. A sixth approach simulates the manner in which a medication may change neural connectivity (step 812), either by enhancing neurotrophic drive, stimulating the “sprouting” of dendritic or axonal processes, or by changing the processes by which these connections are eliminated.

In applying a test compound's physiological data to the relevant disorder's computational model (steps 802 through 810), the information of the test compound's effects on individual neurons or its neuron-to-neuron (synaptic) behavior may be unknown. In such cases, it is necessary to first gather data experimentally by in vitro exposure of neurons to the test compound, and to measure the effects of the test compound on individual neuron behavior and synaptic response characteristics.

Referring back to FIG. 6, once the computational network model has been joined with data on the test compound's known effects (step 606), it becomes possible to determine whether application of the drug has modified the behavior or functioning of the network model for the better (step 608). For example, in an Alzheimer's model, a decrease in behavior analogous to psychiatric or neurological disorders could show improved recall performance. In a seizure disorder model, the network model may exhibit altered oscillatory behavior. To this end, groups of model performance behaviors, analogous to groups of well-defined clinical performance or behavior measures, may be employed. In particular, the gross electrical behavior of a computational model, as measured by a simulated local field potential or simulated electroencephalogram (EEG) can be used as an outcome measure analogous to EEGs recorded clinically, either by scalp or implanted electrodes. Therefore, to the extent to which a test compound, implemented in a computational model, decreases seizure-like model behaviors in the model, that test compound is potentially effective at treating epilepsy or other seizure disorders.

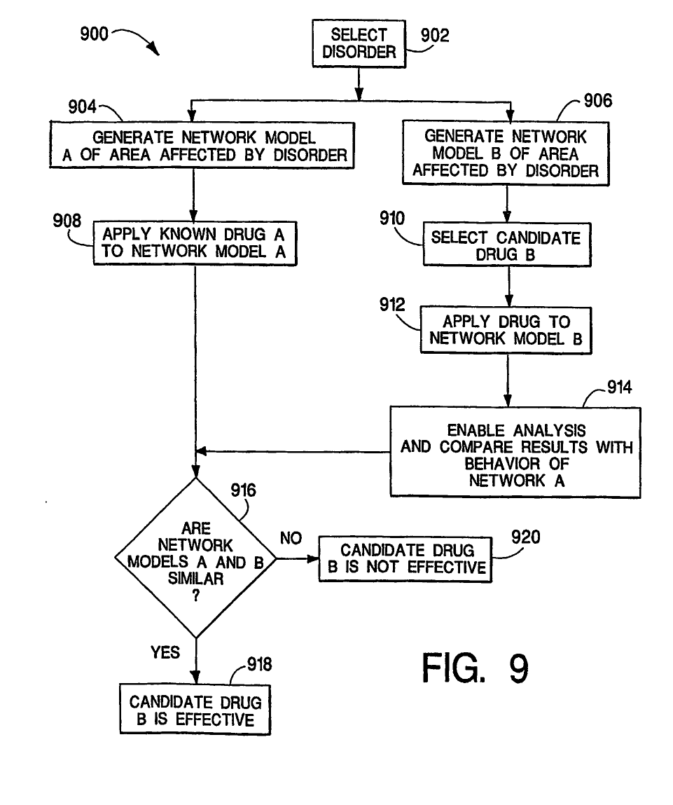

Referring to FIG. 9, a second method for using computational network models to evaluate or screen potentially effective test compounds includes comparing the effects of test compounds with the effects of medications already known to be effective.

In this method (step 900), after a disorder is selected and identified (step 902), a computational model of an area of the brain known to be dysfunctional in the disorder in question, i.e., schizophrenia, is generated (steps 904 and 906). Two models A and B can be simultaneously generated. As described previously for schizophrenia, the prefrontal cortex or temporal lobes are modeled, whereas for Alzheimer's disease, the basal forebrain structures are modeled. In this embodiment, the computational network models are not developed based on analogies with clinically observed behaviors (as in the systems and methods described with respect to FIGS. 6-8). Instead, the neuropathology of the brain structures involved in brains suffering from the disorder is modeled based on what is already known at the neuroanatomic and neurophysiologic level.

Once the computational network model of an area of brain disorder is generated (step 904), a known drug A is applied (step 908) to the computational network model A. As described previously, the virtual application of a drug compound to the constituent computational neurons of the model can draw on: the manner in which receptor-mediated events affect cells' behavior at the ion channel or synaptic level; data on changes in the neurophysiologic properties of ion channels triggered by receptor activation; or on the effects of certain classes of chemicals on neuronal firing rates. Thus, the computational network model information about compounds that are known to be effective in treating schizophrenia is applied (step 906) as discussed in connection with step 606 of FIG. 6. For example, when the model is one of schizophrenia, the effects of various neuroleptics (e.g., THORAZINE®, HALDOL®, ZYPREXA® can be simulated in step 906.

Similarly, a test compound B is selected (step 910) for computer-based screening. The network information about the test compound is applied (step 912) to the network model B. The resultant network behavior is then examined and analyzed (step 914). After the effects of the known effective medication or drug are applied (step 906), the functioning of both network models A and B are examined by comparing the network behaviors (step 916) of computational network models A and B. Specifically, network behavior common to both the known drug and the test compound are noted. This can include, for example, any characteristic spatial patterns of neuron activation, or any distinctive temporal patterns in the manner in which the neural patterns of activation transition from one state to another.

To the extent that the behavior of the computational network models resemble each other, the test compound B can be classified as being potentially effective in treatment of the disorder (step 918). Conversely, to the extent that computational network models differ in behavior, the test compound B can be classified as being ineffective in the treatment of the disorder (step 920).

In this second drug screening method (step 900), the screening of test compounds is based on a direct comparison with medications known to be effective. This second method 600 achieves this by first creating a computational network model of dysfunctional neural tissue and subsequently applying, to the computational network model thus created, information about drugs known to be effective in treating this disorder. The behavior of the system under the influence of the unknown test compound, when compared to the resultant model of the known drug, provides an indication of the test compounds potential effectiveness for treatment.

Computer Implementations

In the embodiments described above, the computational steps of the new systems and methods are implemented on a computer system or on one or more networked computer systems to provide a powerful and convenient facility for forming and testing computational network models of biological systems.

FIG. 10 illustrates an exemplary computer system 1000 suitable for implementation of the new systems and methods.

The computer system 1000 is illustrated as a single hardware platform including internal components and being linked to external components. The internal components of the computer system 1000 include a processor element 1002 interconnected with a main memory 1004. For example, computer system 1000 can include an Intel® Pentium based processor.

The external components include a mass storage 1006. The mass storage 1006 can be one or more hard disks packaged together with the processor 1002 and the memory 1004. Other external components include a user interface device 1008, which can be a monitor and keyboard, together with a pointing device 1010, which can be a “mouse,” or other graphic input devices (not illustrated). Typically, the computer system 1000 is also linked to other local computer systems via a bus 1020, remote computer systems, or wide area communication networks, such as the Internet. The network link allows the computer system 1000 to share data and processing tasks with other computer systems.

Several software components, which will be described in greater detail below, are loaded into memory during operation of this system. The software components collectively cause the computer system 1000 to finction according to the new methods of this invention. These software components are typically stored on the mass storage 1006. Alternatively, the software components may be stored on removable media such as floppy disks or CD-ROM media (not illustrated). A software component 1012 represents an operating system (OS) responsible for managing computer system 1000 and its network interconnections. The OS can be, e.g., of the Microsoft® Windows, i.e., Windows® 95, Windows® 98, Windows® NT, or a Unix operating system, such as Sun Solaris®. A software component 1014 represents common languages and functions present on the computer system 1000 to assist programs implementing the methods specific to this invention. Various programming languages that can be used to program the analytic methods of this invention include C, C++, and the like.

The new systems and methods are programmed in mathematical software packages, which allow symbolic entry of equations and high-level specification of processing, including special algorithms to procedurally program individual equations or algorithms. The computational models described previously can be implemented, using freeware packages such as GENESIS (General Neural Simulation System). GENESIS is a general purpose simulation platform developed to support the simulation of neural systems ranging from complex models of single neurons to simulations of large networks made up of more abstract neuronal components. Most GENESIS applications involve realistic simulations of biological neural systems. Other simulation software such as NEURON, described in Hines, et al., “The NEURON simulation environment, Neural Comput., 9, 1179- 1209 (1997), may be used. A software component 1016 represents the analytical methods as programmed in a procedural language or symbolic package such as GENESIS.

Referring to FIG. 11, the software implementation of the computer system 1000 may include a number of separate software components interacting with each other. An analytic software component 1102 represents a database containing data for the operation of the computer system 1000. Such data generally includes, but is not necessarily limited to, results of prior computations, network model data, and/or clinical data. An analytic software component 1104 represents a data reduction and computational component that include one or more programs which execute the analytic methods, including the methods for testing a network model, as described in FIG. 6 and 9. Analytic software component 1106 includes a user interface (UI), which provides a user of the computer system 1000 with control and input of test network models, and, optionally, known data related to the drug screening processes. The user interface may include a drag-and-drop interface for specifying hypotheses to the system as shown in FIG. 1. The user interface may also include loading of network models or clinical data from the mass storage component (e.g., the hard drive), from removable media (e.g., floppy disks or CD-ROM), or from a different computer system communicating with the computer system 1000 over a network (e.g., LAN, WAN, wireless). An analytic software component 1108 represents the control software, also referred to as a UI server for controlling other software components of the computer system 1000.

The invention is further described in the following examples, which do not limit the scope of the invention described in the claims.

### EXAMPLES

### Example 1

### Computer Model of Normal Hippocampus

The hippocampus is divided into four subfields, CA1-4 (“CA” stands for “cornu ammonis,” another name for the hippocampus suggestive of its resemblance to the ram's horn on the head of the Egyptian deity Ammon).

A computational model that represents tissue from the CA1 subfield of the hippocampus was constructed as follows.

A computer model representing a tissue sample from a rat brain was created. The virtual sample (hereafter, “the sample”) extended 154 microns in the septo-temporal and transverse directions, and 634 microns in the direction orthogonal to those two directions. The resulting sample, which extended from the stratum lacunosum-moleculare (“SL”) layer of the hippocampus to the alveus, included 400 pyramidal cells and 52 interneurons. The intemeurons included 16 parvalbumin (“PV”) cells, 6 calbindin (“CB”) cells, 9 calretinin (“CR”) cells, and 4 cholecystokinin (“CCY”) cells. This sample was then simulated by a computational model that did not distinguish between subspecies of each of these species of intemeuron, except of the basis of their axonal projection patterns. The dendritic morphology and ion channel distribution for all intemeurons were assumed to be the same.

Because of constraints on computational resources, the number of cells in the computer model was 452, only a fraction of the cells in the hippocampus. Even with this limited number of cells, twenty-four hours were required to simulate two seconds of brain activity with a high-speed dual-processor personal computer. However, because the computer model featured many similar cells performing computationally intensive tasks and passing results to other cells, it would have been possible to harness multiple computers operating in parallel. A version of GENESIS, known as P-GENESIS, or parallel GENESIS, has been optimized for causing computers with parallel architectures to cooperate with each other.

Each pyramidal cell was modelled using the 64 compartment pyramidal cell model described by Traub, et al., “A Branching Dendritic Model of a Rodent CA3 pyramidal neurone,” Journal of Physiology 1004, 481: 79-95 Ppt, 1). The intemeuron cells models were based on the model described by Traub and Miles, “Pyramidal Cell-to-Inhibitory Cell Spoke Transduction Explicable by Active Dendritic Conductances in Inhibitory Cell,” Journal of Computational Neuroscience, 1995, 2(4):291-298. Both models included a representation of the internal calcium ion concentrations, realistic arborizations, and representations of the Na⁺, Ca⁺⁺, K⁺_{DR} , K⁺_{AHP}, K⁺_{C}, and K⁺_{A} ion channels. Initial segments of the axons were modeled as compartments, however axons themselves were modeled only as delays.

Population densities of intemeuron subtypes in the model for each hippocampal layer were calculated from known population densities. Suitable data obtained from 60 micron hippocampal slices was given by Freund and Buzsaki, “Intemeurons of the Hippocampus,” Hippocampus, 1996, 6(4):347-470. Densities of pyramidal cells in the stratum pyramidale of the CA1 subfield are available from Boss, et al., “On the Numbers of Neurons in Fields CA1 and CA3 of the Hippocampus of Sprague Dawley and Wistar Rats,” Brain Research, 1987, 406(1-2): 280-287. Within a particular stratum, the neuron distribution was modeled as randomly distributed throughout that stratum.

The spatial distribution of synapses between axons and dendrites of the hippocampus was modeled by determining a distribution of axonal arborization associated with particular morphological classes of neurons. Then, for each class of neurons, a distribution of synaptic targets was defined. The synaptic targets were characterized by the stratum containing the target, the targeted neuron species (i.e. pyramidal cell or intemeuron), and the synaptic target area (i.e., initial segment, soma, or dendrite). For each species, the spatial bouton densities of the axonal projection cloud were calculated. The distribution of synaptic targets was then used to apportion, to each neuron of a particular species, a distribution of synapses consistent with the spatial bouton densities for that neuron species.

Table 1, reproduced below, summarizes the computer model's assumptions concerning the axonal arborizations associated with neuron species located in particular strata. For example, according to Table 1, the model assumed that 45% of PV neurons in the stratum oriens (“SO”) layer of the hippocampus had basket axonal arborizations, 45% had chandelier patterns, and the remaining 10% had bistratified axonal arborizations. CB cells were assumed to be bistratified in the SO, SR, and SL layers and radiatum-projecting in the SR layer. All CB cells in the SL layer and the SO layer were bistratified. CB cells in the SR layer were evenly split between bistratified and radiatum-projecting arborizations. CR cells were assumed to be intemeuron projecting in the SO, SP, SL, and SR layers. SOM cells were assumed to have oriens-lacunosum moleculare arborizations in the SO layer and not to exist in any other layer. CCK cells were assumed to be in the SO, SP, and SR layers and were assumed to have basket arborizations in each of those layers. PC cells were assumed to lie only in the SP layer and to have the pyramid cell arborization in that layer.

TABLE 1

| | | | PERCENTAGE |
|---|---|---|---|
| | HIPPOCAMPAL | AXONAL | OF |
| CELL TYPE | LAYER | ARBORIZATION | POPULATION |
| PV | SO | bask | 0.45 |
| PV | SO | chan | 0.45 |
| PV | SO | bist | 0.10 |
| PV | SP | bask | 0.45 |
| PV | SP | chan | 0.45 |
| PV | SP | bist | 0.10 |
| CB | SO | bist | 1.0 |
| CB | SR | bist | 0.5 |
| CB | SR | radi | 0.5 |
| CB | SL | bist | 1.0 |
| CR | SO | intr | 1.0 |
| CR | SP | intr | 1.0 |
| CR | SL | intr | 1.0 |
| CR | SR | intr | 1.0 |
| SOM | SO | o-lm | 1.0 |
| CCK | SO | bask | 1.0 |
| CCK | SP | bask | 1.0 |
| CCK | SR | bask | 1.0 |
| PC | SP | pyra | 1.0 |

Abbreviations for axonal arborizations are as follows: “bask” means “basket,” “chan” means “chandelier (axo-axonic),” “bist” means “bistratified,” “intr” means “intemeuron projecting,” “radi” means “radiatum-projecting,” and “o-lm” means “oriens-lacunosum moleculare,” and “pyra” means “pyramidal axon arborization.” Abbreviations for the four layers of the hippocampus are as follows: “SR” means “stratum radiatum,” “SP” means “stratum pyramidale,” “SL” means “stratum lacunosum moleculare,” and “SO” means “stratum oriens.” Abbreviations for the neuron classes in Table 1 are as follows: “PV” means “parvalbumin,” “CB” means “calbindin,” “CR” means “calretinin,” “SOM” means “somatostatin,” “CCK” means “CCK immunoreactive cell,” and “TC” means “pyramidal cell.”

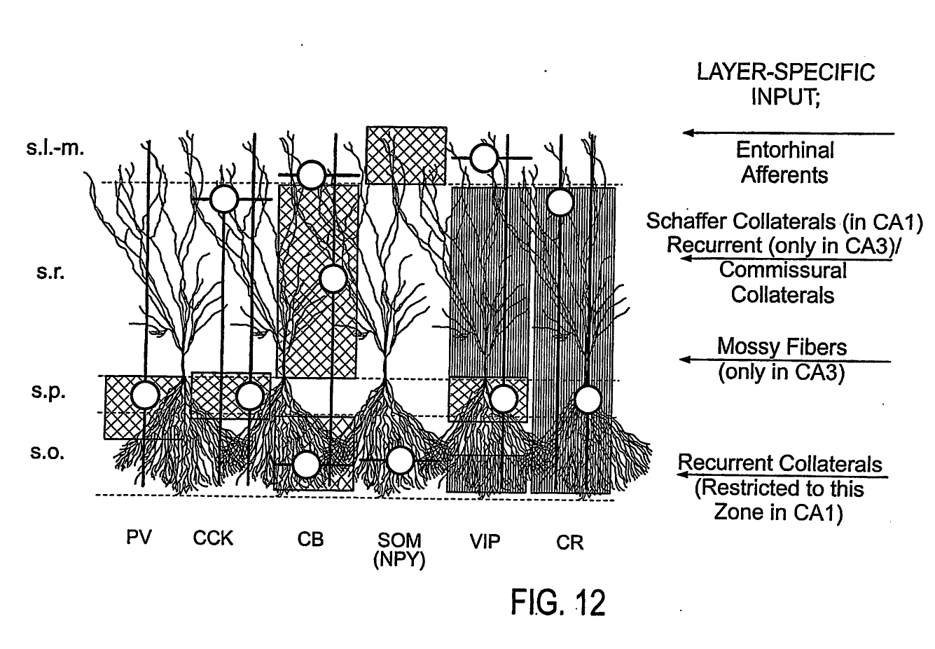

FIG. 12 summarizes, in graphical form, the axonal and dendritic arborizations of various intemeuron species. The dark circles indicate the cell body location of each of the intemeuron types; the dark lines emanating from dark circles show the orientation and laminar distribution of the dendritic tree. The hatched boxes show the layers in which the axons of each intemeuron species typically arborize. The vertically striped boxes indicate that other intemeurons, rather than pyramidal cells, are the primary targets. Pyramidal cells are shown in outline in the background to provide an idea of which membrane domains (somatic, proximal, or distal dendritic regions) are innervated by the various intemeuron types. For example FIG. 12 indicates that PV interneurons project to stratum pyramidale and the proximal area of stratum oriens.

PV cells have been found to be predominantly either basket cells or chandelier cells. In the CA1 subfield, a small number of PV cells have been found to have a bistratified axon projection pattern. Thus, the model assumed that 10% of all PV cells were bistratified, with the remainder evenly divided between basket and chandelier cells.

Certain intemeurons stain as both CB and SOM cells. In the computer model, such intemeurons were modeled as SOM cells. CB cells are known to innervate the dendrites of pyramidal cells. There are three known subspecies of CB cells, each of which is represented in Table 1. Except for half of the CB cells in the SR, all CB cells were assumed to have a bistratified axonal arborization.

The CR intemeurons target the dendritic processes of other intemeurons. Therefore, in the model, CR cells were assumed to have an intemeuron-projecting arborization, regardless of which layer they were found in.

Within the CA1 hippocampal subfield, SOM cells are believed to be o-lm cells and to have soma within the SO layer. As shown in Table 1, the model also made this assumption.

Virtually all CCK-immunoreactive cells are believed to have a basket axonal arborization. As shown in Table 1, the model made the same assumption.

Finally, PC cells are assumed to populate only the SP layer. All PC cells in the model were assumed to have pyramidal axon arborization.

Having modeled the population of cells in each layer and the morphological category to which they belong, we then modeled the connectivity between neurons. This was done by providing the model with assumptions about the targets corresponding to each axonal arborization. Assumptions concerning the targets of an axonal arborization were derived from studies in which an axon of a particular intemeuron type was labeled with an anteriograde tracer to allow visualization of the entire axon with all its ramifications.

Quantitative estimates of spatial synaptic density for each of the interneuron classes were derived from studies in which axonal projections of each of a number of different classes of intemeurons were anteriogradely stained. On the basis of tissue sections, theses studies provided an estimate of a total (linear) axonal distance per volume and a spatial bouton (synapse) frequency, in boutons per length of axon.

In implementing the present model, several simplifying assumptions were made: (i) for a given cell, bouton density was assumed to be a flnction of the calcium-binding protein of the intemeuron, (ii) spatial bouton density was assumed to be invariant with septo-temporal or transverse distance from the parent cell, and (iii) for a given intemeuron type, bouton density was assumed to be invariant across strata. The values used in the model, in units of synapses per cubic millimeter were as follows: PV 2.12×10⁵, CB 1.13×10⁴, CR 6.36×10³, SOM 4.21×10⁵, CCK 2.12×10⁵.

It is believed that CA1 axons course through the SO toward the alveus, giving off occasional collaterals as they do so. Thus, in the new computer model, we assumed that connections between pyramid cells occur only in the SO on the cells'basal dendrites. Postsynaptic targets, as percentages, are not readily available for pyramidal cells. The model thus assumed that the ratio of the number of connections between pyramid cells and the number of connections between pyramid cells and interneurons was roughly proportional to their relative abundance in the SO layer.

Spatial bouton density in pyramidal axons was calculated, as described above in connection with intemeurons to be 9.09×10⁴ synapses per cubic millimeter.

Table 2 summarizes the model assumptions concerning connectivity between neurons. Each row in Table 2 corresponds to a type of axon arborization, and each column corresponds to a particular hippocampal layer. At the intersection of a row and column is a 2×3 connectivity matrix that summarizes the connectivity of a particular axon arborization present in that hippocampal layer.

TABLE 2

| | SO | | | SP | | | SR | | | LM | | |
|---|---|---|---|---|---|---|---|---|---|---|---|---|
| chan | 1 | 0 | 0 | 1 | 0 | 0 | 1 | 0 | 0 | 0 | 0 | 0 |
| | 0 | 0 | 0 | 0 | 0 | 0 | 0 | 0 | 0 | 0 | 0 | 0 |
| bask | 0 | 0 | 0 | 0.02 | 0.53 | 0.45 | 0 | 0 | 0 | 0 | 0 | 0 |
| | 0 | 0 | 0 | 0 | 0 | 0 | 0 | 0 | 0 | 0 | 0 | 0 |
| bist | 0 | 0 | 0.93 | 0 | 0 | 0 | 0 | 0 | 0.93 | 0 | 0 | 0 |
| | 0 | 0 | 0.07 | 0 | 0 | 0 | 0 | 0 | 0.07 | 0 | 0 | 0 |
| intr | 0 | 0 | 0 | 0 | 0 | 0 | 0 | 0 | 0 | 0 | 0 | 0.5 |
| | 0 | 0 | 1.0 | 0 | 0 | 1.0 | 0 | 0 | 1.0 | 0 | 0 | 0.5 |
| o-lm | 0 | 0 | 0 | 0 | 0 | 0 | 0 | 0 | 0 | 0 | 0.03 | 0.86 |
| | 0 | 0 | 0 | 0 | 0 | 0 | 0 | 0 | 0 | 0 | 0.11 | 0 |
| radi | 0 | 0 | 0 | 0 | 0 | 0 | 0 | 0 | 0.93 | 0 | 0 | 0 |
| | 0 | 0 | 0 | 0 | 0 | 0 | 0 | 0 | 0.07 | 0 | 0 | 0 |
| pyra | 0 | 0 | 0.8 | 0 | 0 | 0 | 0 | 0 | 0 | 0 | 0 | 0 |
| | 0 | 0 | 0.2 | 0 | 0 | 0 | 0 | 0 | 0 | 0 | 0 | 0 |

The first row of each connectivity matrix provides data on how the particular axon arborization connects to pyramid cells, and the second row provides data on how that axon arborization connects to intemeurons. The three columns in the connectivity matrix correspond to different parts of the target cell to which the particular axon arborization can connect. From left to right, these are the initial segment, the soma, and the dendrites.

For example, Table 2 shows that in the model, a bistratified axon arborization present in the SO layer was assumed to connect to a dendrite on a pyramid cell with probability 0.93, and to connect to a dendrite on an intemeuron with probability 0.07. Basket axon arborizations were assumed to exist only in the SP layer and to connect only to pyramid cells. Within the SP layer, the basket axon arborization can connect to all three parts of the pyramid cell, but only rarely to its initial segment (with probability 0.2).

The model assumptions shown in Table 2 were derived from known studies in which axons of a particular intemeuron type were labeled with an anteriograde tracer, allowing visualization of the entire axon with all of its ramifications. For example, it is known that o-lm cells project only to LM; that of the total number of synaptic connections they form there, 86% are on dendrites of pyramidal cells, 3% are on pyramidal cell soma, and 11% are on intemeuron soma. Analogous data has been derived from similar experiments on the other intemeuron classes.

Data underlying Table 2 can be found in a variety of publications. For example, Katona, et al., “Postsynaptic targets of somatostatin-immunoreactive intemeurons in the rat Hippocampus,” Neuroscience, 1999. 88(1):37-55 reports that o-lm cells project only to the LM, and that of the total number of synaptic connections they form there, 86% are on dendrites of pyramidal cells, 3% are on pyramidal cell somata, and 11% are on intemeuron somata. Similar data for basket cells is found in Halasy, et al., “Synaptic Target Selectivity and Input of GABAergic Basket and Bistratified Intemeurons in the CA1 Area of the Rat Hippocampus,” Hippocampus, 1996. 6:306-329. Data for bistratified cells is found in Gulyas, et al., “Pyramidal cell dendrites are the primary targets of calbindin D28k-immunoreactive intemeurons in the hippocampus,” Hippocampus, 1996. 6(5):525-34. Data for oriens-lacunosum-moleculare cells is also found in Katona, et al., cited above. Data for pyramidal cells is found in Somogyi, P., et al., “Salient features of synaptic organization in the cerebral cortex,” Brain Research Reviews, 1998, 26:113-135. Regarding intemeuron-projecting cells, Gulyas et. al. “Interneurons containing calretinin are specialized to control other intemeurons in the rat hippocampus,” J. Neurosci, 1996, 16(10):3397-411 states that CR intemeurons synapse with dendrites of other intemeurons.

Because of constraints on the data structure used in implementing the model, certain simplifying assumptions were made. For example, it is believed that CR intemeurons synapse with dendrites of other interneurons, with the following caveats: (a) CB intemeurons avoid PV intemeurons; (b) when CR interneurons contact other CR intemeurons, they do so at both dendrites and at soma; and (c) CR intemeurons form dendro-dendritic contacts (gap junctions) with one another. These subtleties were ignored in the present model, in part because of a paucity of experimental data for incorporating into the model.

In addition to modeling the population of neurons and their steric relationships, we also modeled synaptic connections. In the new model, this synaptic conductance was assumed to obey the function

$${g}_{syn} ( t ) = \frac{{Ag}_{max}}{{τ}_{1} - {τ}_{2}} ( {ⅇ}^{- 1 / {τ}_{1}} - {ⅇ}^{- 1 / {τ}_{2}} ) , for {τ}_{1} > {τ}_{2} ,$$

where τ₁ and τ₂ are time constants associated with the synapse and A is a normalization constant chosen such that g_{syn} reaches a maximum of gₘₐₓ.

At the GENESIS level, neurotransmitter release into the synaptic cleft is not explicitly modeled. Rather, the synchan object is placed postsynaptically. When a “SPIKE” message is received by the synchan object, it activates according to parameters set in its fields.

All interneurons form GABAergic synapses on their target cells. Pyramidal cells form excitatory synapses on their target cells, either AMPA or NMDA, with a 0.5 probability for each. Channel characteristics, in terms of values given in the foregoing equation, are presented in Table 3.

TABLE 3

| | E(volts) | τ₁ (sec) | τ₂ (sec) | gmax (nS) |
|---|---|---|---|---|
| AMPAp | 0 | 0.0536 | 0.00132 | 8 |
| NMDAp | 0 | 0.1440 | 0.00100 | 6 |
| GABAp | −0.075 | 0.0094 | 0.00100 | 3 |
| AMPAi | 0 | 0.0536 | 0.00132 | 6 |
| NMDAi | 0 | 0.0540 | 0.00130 | 2 |
| GABAi | −0.075 | 0.0094 | 0.00100 | 0.5 |

In the computer model, all synaptic stimulation to cells (except for the initial stimulation) arose from cells within the model. Because the model represented only a very small piece of tissue, the innervation of a typical cell in the model was considerably lower than that of hippocampal cells in vivo. For example, actual CA pyramidal cells receive about 30,000 excitatory and 1,700 inhibitory inputs, which is orders of magnitude greater than the number of synaptic inputs received by pyramidal cells in the present model. To compensate, gₘₐₓ for all synaptic conductances was weighted by a dimensionless scale factor. The weight factor was obtained experimentally by gradually increasing it and re-running the computer model until pyramidal intemeuron outputs showed realistic spike waveforms. A suitable weight factor for the foregoing computer model was 300.

Initial Stimulus

A computer model of neural tissue, no matter how realistic, will do nothing unless it receives an initial stimulus. Once subjected to a stimulus, the computer model evolves through a series of states. This evolution depends on the various parameters defined above.

In the present example, the initial excitation was selected to be biologically realistic, but not necessarily to contain any information. The initial excitation chosen was to set all potentials to zero and then to excite each neuron for one second using a pulse sequence having a mean frequency of 15 Hz. The excitation frequency and phase were both random to avoid the possibly unrealistic effect of synchronicity between neurons. The simulated trans-membrane potentials in each neuron in the model were periodically recorded.

Output from Normal Model

The foregoing pattern of initial excitation produced an initial transient period that lasted approximately 0.5 seconds. Following this transient period, the simulated neuron potentials settled into a normal pattern of spike waveforms. Data from this transient period was excluded from our analysis because such data would not have been biologically realistic.

The raw output provided by the model after simulation included 452 time-varying voltages. Because of difficulty inherent in interpreting such copious data, it was useful to implant “virtual electrodes” at 16 locations throughout the simulated tissue block to record local field potentials averaged over a volume of tissue. The virtual electrodes were created by summing local field potentials at points surrounding the desired location of the virtual electrode. The output of such a virtual electrode was given by a sum of local field potentials at discrete points weighted by the distances between the discrete points and the location of the virtual electrode:

$$Φ = \frac{1}{4 π s} {\sum }_{i = 1}^{n} \frac{{I}_{mi}}{{R}_{i}}$$

where Φ is the field potential in volts, s is conductivity of the medium surrounding the neurons (in mhos), Iₘᵢ is the transmembrane current (in amperes) across the i^{th} neural compartment, and Rᵢ is the distance from the i^{th} neural compartment to the virtual electrode. The sum was evaluated over every computational compartment of every neuron in the simulation.

Table 4 compares the average spike rates (in Hertz) in the model with approximate spike rates (also in Hertz) as measured in rats engaged in a variety of tasks. These tasks include performing trials on radial 8-arm maze task (column “a”); paradoxical sleeping (column “b”), slow-wave sleeping (column “c”), and being in a “maximum” behavioral state (column “d”).

TABLE 4

| | model | (a) | (b) | (c) | (d) |
|---|---|---|---|---|---|
| pyramidals | 2.45 | 2 | 0.1-0 | 0.5-5 | <20 |
| interneurons | 25.6 | 15 | 30-100 | 10-40 | 30-100 |

The average spike rate for all pyramidal cells in the model was on the order of 2.45 Hz, and for all interneurons to be 25.6 Hz. Of the 452 cells in the model, 122 spiked at least once during the simulation. This is consistent with published results for corresponding in vivo spike rates.

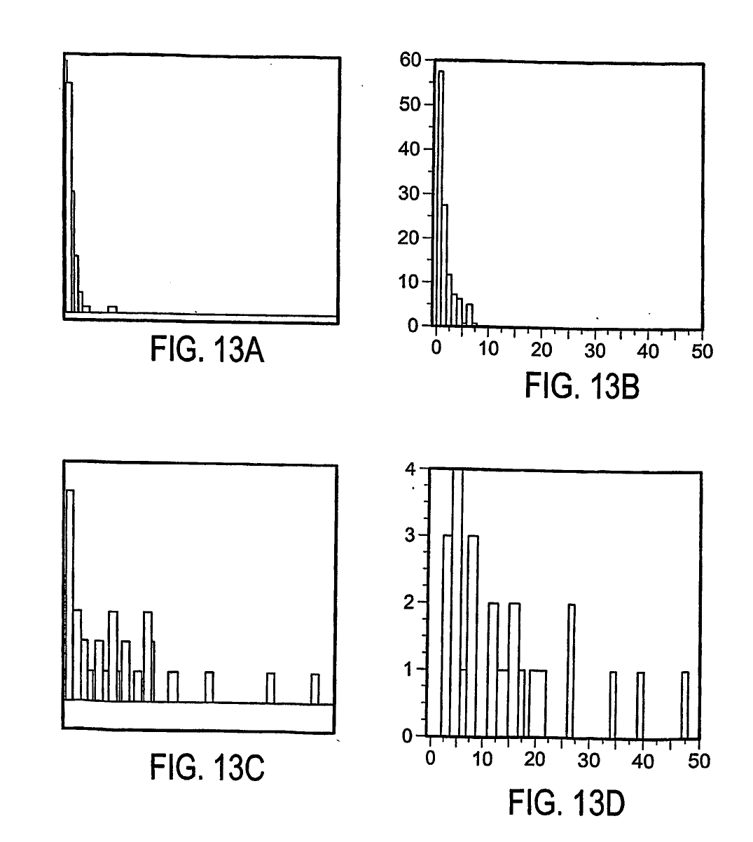

The distribution of spike rates in vivo also matches the corresponding distribution of spike rates in the model. For example, FIG. 13A shows a histogram distribution of spike rates for pyramidal cells in the model. FIG. 13B shows a histogram of corresponding spike rates as measured in vivo in a rat hippocampus. FIG. 13C and 13D are corresponding histograms for interneuron spike rates in both the computer model (FIG. 13C) and in the rat (FIG. 13D).

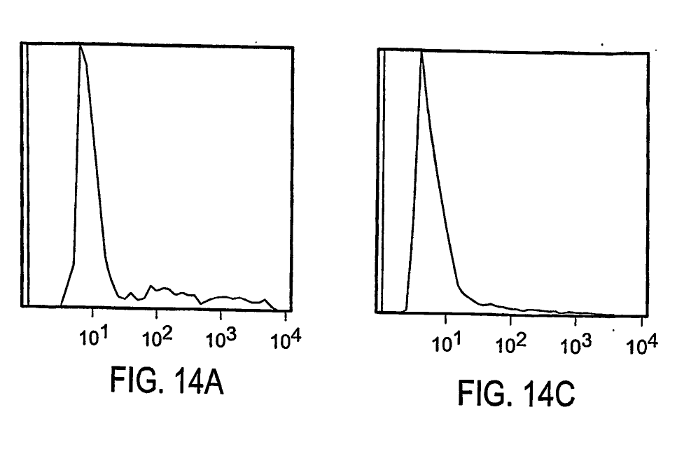

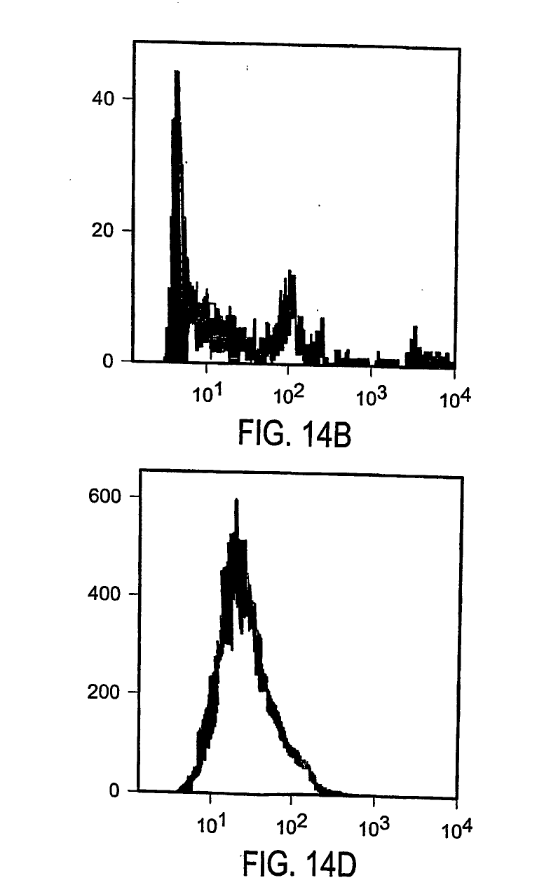

The distribution of intervals between spikes in vivo also matches the corresponding distribution of intervals in the model. For example, FIGS. 14A-14D show the distributions of the intervals between spikes for pyramid cells (FIGS. 14A-14B) and intemeurons (FIGS. 14C-14D). FIGS. 14B and 14D show measured interval distributions as measured in vivo from a rat hippocampus, and FIGS. 14A and 14C show modeled interval distributions. Comparison of these figures indicates that the interval distribution of the model matches that obtained in vivo.

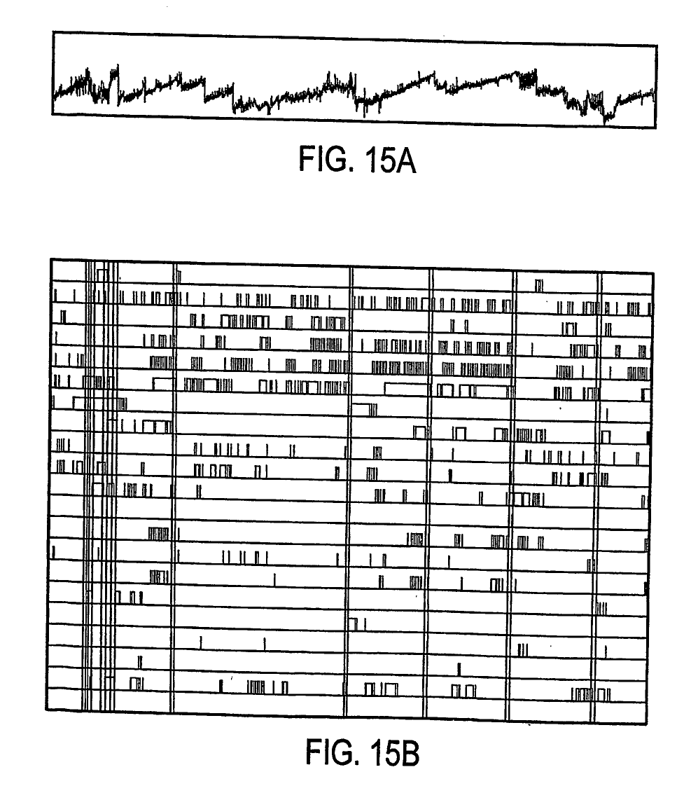

By observing the evolution of the spatial distribution of voltage potentials over all the neurons, it was possible to identify activity “epochs” of relative stability, separated by short transition periods. In FIG. 15B, a firing pattern for a subset of twenty neurons reveals a number of these stable epochs. The lengths of these epochs did not appear to change for small changes in the parameters of the model.

Inspection of the spike train of a single neuron in many cases revealed episodes of fast firing followed by episodes of markedly slower firing. Using this data, we defined a transition point as occurring when the sequential inter-spike interval ratio (ISI(t)/ISI(t+1)) was either very large, indicating the beginning of a fast-spiking episode, or very small, indicating end of such an episode. When a sufficient number (referred to as a “threshold number”) of neurons experienced a transition point within an adequately narrow time window, a transition between activity epochs was said to occur. When using parameter values for sequential ISI ratio, threshold, and time window of 14, 10, and 33 msec, respectively, the system exhibited seven transitions, which defined eight activity epochs. This behavior was robust to small changes in parameter values. It was seen, to a greater or lesser degree, in all local field potentials measured by all the virtual electrodes in the model. A representative trace, from a virtual electrode in the stratum pyramidale is shown in FIG. 15A.

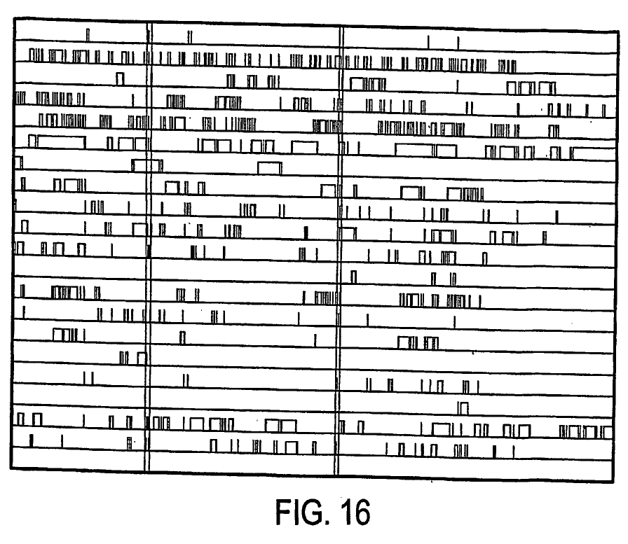

Inspection of the data indicated that many transitions between epochs were preceded by the progressively slower firing of a number of cells. This is consistent with spike frequency adaptation (SFA), a process that is mediated by slow Ca⁺-activated K⁺channels. Removing the I_{AHP} channels from the constituent neurons of the hippocampus model disables SFA. When this was done, and the model subjected to the same initial excitation, only three activity epochs were present in the same time period. A portion of the resulting firing pattern is shown in FIG. 16.

The stable states, or epochs, behave consistently with the attractor states described in the neural network literature. As discussed earlier, in a neural network, attractors are stable fixed points of the system that correspond to minima of the network's energy function over all values of its state-space. It has been theorized that these states, occurring in biological neural tissue, represent memories. Hence, the matrix of neural connections is the storage medium for these memories.

It is therefore useful to consider whether the epochs are in fact attractors. To do so, we defined a weight matrix, W, and an input vector \overline{V}ₙᵢ .

The weight matrix was a 452×452 element array W of elements Wᵢⱼ. Each W_{if} represented the strength of synaptic stimulation (excitatory or inhibitory) that neuron i exerted on neuron j. For example, if neuron i were a pyramidal cell that sent x synaptic contacts to neuron j, then Wᵢⱼ would have been x. If neuron i were instead an interneuron, then Wᵢⱼ would have been −x.

The input vector \overline{V}ₙᵢ had the same number of elements as there were neurons in the model (in this case 452 elements). This vector represented the normalized activation pattern of all cells in the system during a particular epoch, n. \overline{V}ₙᵢ was obtained by calculating the spike rate of cell i during epoch n, then normalizing the spike rates of all cells so that all elements of \overline{V}ₙᵢ lay in the interval [0, 1]. This was consistent with the assumption of rate-coded information.

The simulation was implemented using the GENESIS neural modeling language and run under LINUX on a dual-processor PC as described in Bower, J. M. and D. Beeman, The Book of GENESIS. Exploring Realistic Neural Models with the GEneral NEural Simulation System. 1995, Santa Clara, Calif. The individual pyramidal cell and interneuron models were ported to GENESIS by Sampat and Huerta and Menschik and Finkel, respectively. Both models are available on the internet at genesis-sim.org/BABEL/babeldirs/cells. C programs to specify cell placement and connectivity are designed to read parameter files in the form presented in Tables 1 and 2. This allows the model to be updated as additional neuroanatomic information becomes available. In addition, this allows the model to be selectively altered to simulate the effects of lesioning.

### Example 2

### Computer Model of Schizophrenic Hippocampus

Although the neuropathological lesion of schizophrenia is not known with certainty, postmortem studies on the hippocampi of human schizophrenics indicate abnormalities in wiring, distribution of cell types, particularly interneurons, and in particular, PV interneurons. On the basis of this published data, schizophrenia was simulated by reducing the population of interneurons by 56%. The interneurons removed were PV interneurons because it is believed that the hippocampus of a schizophrenic has fewer such interneurons. The resulting model will be referred to as the “schizophrenic model.”

The remaining interneurons may show subtle changes in connectivity. These changes can be incorporated in the model by altering the data in Table 2. However, any such changes in connectivity remain unaccounted for in the present model of the schizophrenic hippocampus, in part because of a paucity of suitable experimental data.

When the schizophrenic model was re-executed with the same initial stimulus as was applied to the normal model, the number of epochs observed during the run time was reduced from eight to two. This suggested that the frequency of such stable epochs was associated with the presence of schizophrenia.

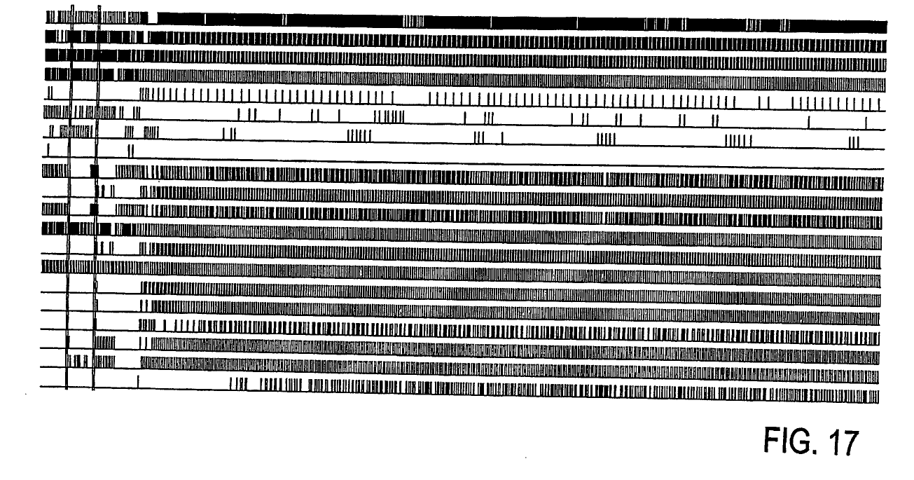

Representative data following application of the stimulus to the schizophrenic model is shown in FIG. 17. Unlike the 5.5 seconds of firing data shown in FIGS. 15B and FIG. 16, FIG. 17 shows only 4.5 seconds of firing data. In addition, the neurons shown in FIG. 17 are primarily pyramidal cells, whereas the neurons shown in FIGS. 15B and 16 are primarily interneurons. Nevertheless, it is clear that the firing pattern in FIG. 17 shows many fewer epochs than does the firing pattern in FIG. 15B. This result indicates that the frequency of transitions between epochs, or equivalently the frequency of epochs may correlate with the presence of schizophrenia. In particular, a lower epoch frequency appears to be associated with schizophrenia As such, a test compound that increases the epoch frequency potentially an effective treatment for schizophrenia.

### Example 3

### Computer Model of Chlorpromazine-Treated Schizophrenic Hippocampus

The effect of chlorpromazine on neural tissue was modeled by changing the conductances of the ion channels of each neuron. A computational model of the manner in which the conductance of sodium and potassium ion channels is given by equations 4.8−4.9 in the Book of Genesis (supra) as follows:

G_{Na}=\overline{g}Nam³h and

G_{K}=\overline{g}_{K}n⁴

G_{ca}=\overline{g}m²h

The conductance of a sodium channel, for example, is the product of a constant term, \overline{g}_{Na}, and two time-varying terms, m³ and h. A computational model of the time-variation of these terms and their voltage dependence is given by equations 4.11−4.13 in the Book of Genesis:

$$\begin{matrix}\frac{ⅆ m}{ⅆ t} = {α}_{m} ( V ) ( 1 - m ) - {β}_{m} ( V ) m \\ \frac{ⅆ h}{ⅆ t} = {α}_{h} ( V ) ( 1 - h ) - {β}_{h} ( V ) h \\ \frac{ⅆ n}{ⅆ t} = {α}_{n} ( V ) ( 1 - n ) - {β}_{n} ( V ) n\end{matrix}$$

The functional form of the alpha(V) and beta(V) term are given by equations 4.21 and 4.22 in the Book of Genesis:

$$\begin{matrix}{α}_{n} ( V ) = \frac{{n}_{∞} ( V )}{{τ}_{n} ( V )} \\ {β}_{n} ( V ) = \frac{1 - {n}_{∞} ( V )}{{τ}_{n} ( V )}\end{matrix}$$

In GENESIS, most ion channels are implemented using the “tabchannel” object. This object allows specification of such fields as \overline{g}, and for specifying the α and β functions.

A computer model of neural tissue exposed to chlorpromazine was obtained by altering the constant term of the conductance equation shown above. In particular, the schizophrenic model is altered by:
halving the value of \overline{g}_{Na} for all sodium ion channels;
by multiplying the \overline{g}_{Ca} value for all calcium ion channels by 0.71;
by multiplying the \overline{g}_{K} value associated with the sustained potassium current (I_{A} or K_{A}) channel by 0.6.

For intemeurons, \overline{g}_{Na} was set to 0.0349 siemens, \overline{g}_{K} was set to 0.0174 siemens, and \overline{g}_{Ca} was set to 0.0047 siemens. For pyramidal cells, \overline{g}_{Na} was set to 0.1229 siemens, \overline{g}_{K} was set to 0.0615 siemens, and \overline{g}_{Ca} was set to 0.0164 siemens.

As data on the time-varying effect of chlorpromazine becomes available, the computer model can be further enhanced by altering the time-varying term consistent with that data.

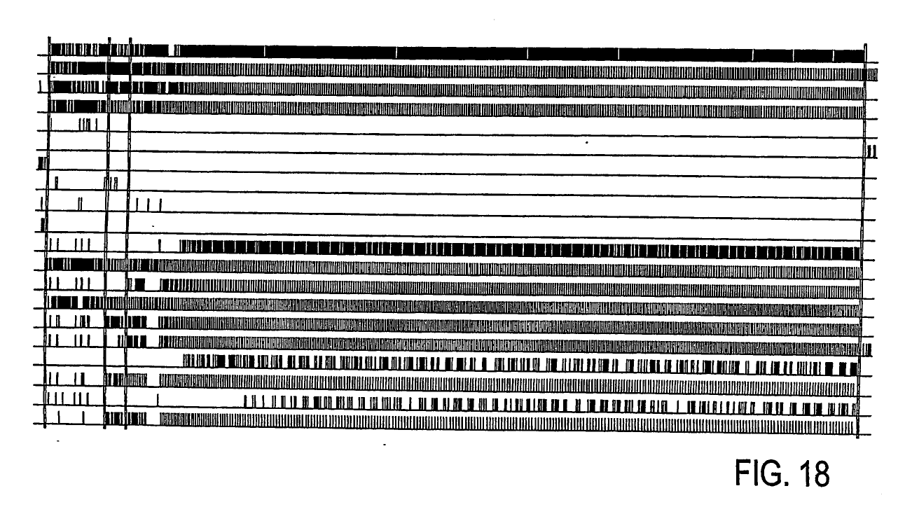

The result of re-executing the model with the foregoing changes is shown in FIG. 18. Comparison of FIGS. 17 and 18 shows that the number of stable epochs is increased from three in FIG. 17 to five in FIG. 18. This suggests that chlorpromazine affects the neural tissue of the schizophrenic model in a way that drives it toward normalcy.

### EXAMPLE 4

### Computer Model of Drugs that Act on Receptors

Not all psychiatric drugs are amenable to modeling by altering ion channel conductances as described above. For other psychiatric drugs, only the effect on neurotransmitter receptors is known. If a drug is known to block a particular dopamine receptor with a known affinity, one can alter the model to simulate this effect.

In particular, the antipsychotic drug olanzapine, sold under the tradename ZYPREZA®, is known to act on several receptors, each of which has downstream ion channel effects. A computer model of hippocampal tissue exposed to olanzapine would thus include changes to simulate the effect of that drug on one or more of those receptors.

In particular, affinities of many drugs for receptors are well known. For example, Goodman and Gilmans “The Pharmacological Basis of Therapeutics,” Tenth Edition. McGraw-Hill, 2001, lists such affinities. The following equation, from Cooper, J R., et al., “The Biochemical Basis of Neuropharmacology,” Seventh Ed., Oxford University Press, 1996, gives the fraction of receptors occupied (r) as function of concentration of drug ([L]) and a dissociation constant, Ki.

$$r = \frac{[ L ]}{[ L ] + Ki}$$

The Ki value, which is inversely proportional to affinity, is the concentration needed to saturate half of the receptors. In Table 20-2 (entitled “Potencies of Standard and Experimental Antipsychotic Agents at Neurotransmitter Receptors”) of Goodman and Gilman's (supra), Ki is given in nanomolar (nM) quantities.

To model the effect of olanzapine on the K+ channel via its antagonism of the Dl receptor, one first obtains olanzapine's Ki for the D1 receptor, which is 31.0. A reasonable value for the free concentration of olanzapine (corrected for binding to plasma proteins) is 27 nM. This value is from Tran, et al, “Olanzapine (Zyprexa) —A Novel Antipsychotic,” Lippincott Williams and Wilkins, 2000. The fraction of occupied receptors, r, is therefore is 0.47.

From Kuzhikandathil, E. V. and Oxford, G. S., “Classic D1 dopamine receptor antagonist R-(+)-7-chloro-8-hydroxy-3-methyl-1-phenyl-2,3,4,5-tetrahydro-1H-3-benzazepine hydrochloride (SCH23390) directly inhibits G protein-coupled inwardly rectifying potassium channels,” Molecular Pharmacology. 62(1): 119-26, 2002, we see that complete D1 antagonism results in a decrease in the magnitude of the K+ current by about 30%. Similar data is available for many receptor-ion channel combinations.

Statistically, approximately 47% of D1 receptors will be blocked (antagonized) at a therapeutic olanzapine level. Therefore, the complete D1 antagonist effect described above is corrected by this amount by decreasing the constant (\overline{g}) term in the equation for conductance. Thus, the baseline \overline{g} is weighted by 0.30×0.47 to arrive at the \overline{g} value for the olanzapine treated neuron.

### EXAMPLE 5

### Computer Model of Drugs that Stimulate Intracellular Second Messengers

Certain other psychiatric drugs operate by changing the activity of intracellular second messengers, such as cAMP. To the extent that a biologically realistic model of neurons includes parameters representative of intracellular second messenger activity, such parameters can be manipulated to simulate the effect of the psychiatric drug.

### EXAMPLE 6

### Application of Computer Model to Drug Synthesis

As described thus far, a biologically realistic model of neural tissue has been applied to modeling the effect of a drug on diseased neural tissue to see if a desirable outcome occurs. However, it is also possible to begin with a desirable outcome and ask what cellular level parameters in the diseased neural tissue must be changed to yield that desired outcome. An answer to this question will provide guidance in the synthesis of drugs to be used for treating the disease.

As an example, consider the case in which a schizophrenic lesion as described above yields a decreased epoch frequency. In the biologically realistic model of the diseased tissue, there may be m parameters that can be adjusted, with each of the m parameters being able to take one of n biologically realistic values. These parameters might be, for example, ion channel conductances, or synaptic conductances. The goal would then be to identify those values of the m parameters that result in a desired epoch frequency.

Although the number of combinations of parameter values can become large, it is nevertheless a finite number that can be efficiently searched for using a variety of known algorithms for searching discrete valued solution spaces of finite extent.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method for screening a test compound for potential efficacy in treatment of a disorder, the method comprising:
creating a first computer model representative of a volume of disease-afflicted neural tissue exposed to the test compound;
providing an initial excitation to the first computer model; and
determining a first outcome indicative of a response of the first computer model to the initial excitation, wherein the first outcome is representative of the efficacy of the test compound at treating the disorder.

2. The method of claim 1, further comprising:
creating a second computer model representative of the volume of disease-afflicted neural tissue, wherein the volume is not exposed to the test compound;
providing the initial excitation to the second computer model; and
determining a second outcome indicative of a response of the second computer model to the initial excitation;
wherein a difference between the first and second outcomes indicates that the test compound is a candidate compound for treating the disorder.

3. The method of claim 2, further comprising:
creating a third computer model representative of the volume of neural tissue free of the disease;
providing the initial excitation to the third computer model; and
determining a third outcome indicative of a response of the third computer model to the initial excitation;
wherein a similarity between the first and third outcomes indicates that the test compound is a candidate compound for treating the disorder.

4. The method of claim 3, wherein determining the potential efficacy on the basis of the first and third outcomes comprises:
determining a first epoch frequency associated with the first outcome; and
determining a test epoch frequency associated with one of the second and third outcomes;
wherein the test compound is a candidate compound for treatment of the disorder when the first epoch frequency is substantially equal to the test epoch frequency and the test epoch frequency is associated with the third outcome, and
wherein the test compound is a candidate compound for treatment of the disorder when the first epoch frequency is greater than the test epoch frequency and the test epoch frequency is associated with the second outcome.

5. The method of claim 1, wherein creating a first computer model comprises:
defining a model of a volume of neural tissue, the model having a population profile of neurons;
altering the model to simulate lesioning caused by the disorder; and
altering the model to simulate an effect of the test compound on the neural tissue.

6. The method of claim 5, wherein altering the model to simulate lesioning caused by the disorder comprises altering the population profile consistent with the disorder afflicting the neural tissue.

7. The method of claim 6, wherein altering the population profile comprises reducing a density of intemeurons in the model.

8. The method of claim 5, wherein altering the model to simulate the effect of a test compound comprises altering ion channel conductances of the neurons consistent with exposure of neural tissue to the test compound.

9. The method of claim 5, wherein altering the model to simulate the effect of a test compound comprises modeling an effect of the test compound on a receptor.

10. The method of claim 5, wherein altering the model to simulate the effect of a test compound comprises modeling an effect of the test compound on an intracellular second messenger.

11. The method of claim 5, wherein altering the model comprises simulating a change in synaptic conductances of neurons.

12. The method of claim 5, wherein defining a model of a volume comprises defining a neural network.

13. The method of claim 1, wherein the volume comprises a volume of a hippocampus.

14. The method of claim 1, wherein the disorder is schizophrenia.

15. The method of claim 1, wherein providing an initial excitation comprises applying a biologically realistic initial excitation.

16. The method of claim 1, wherein providing an initial excitation comprises stimulating each of the neurons with a pulse train having an average pulse-repetition frequency.

17. The method of claim 1, wherein creating a first computer model comprises creating a biologically realistic computer model.

18. The method of claim 1, wherein creating a first computer model comprises creating a Hopfield model.

19. The method of claim 1, wherein creating a first computer model comprises creating a neural network model.

20. The method of claim 1, wherein creating a first computer model comprises:
generating a computational network model of the disorder by generating a normal computational network model of a portion of the human brain manifesting a plurality of normal characteristics of human behavior, and
introducing a digital representation of one or more physiological lesions into the normal computational network model consistent with suspected neuropathology of the disorder;
and wherein the method further comprises
applying physiological data of the test compound to the computational network model; and
determining, based on the application of the physiological data to the network model, the efficacy of the test compound for treating the disorder,
wherein a favorable outcome in the network model indicates that the test compound is a candidate test compound to treat the disorder.

21. The method of claim 20, wherein the disorder is a neuropsychiatric or neurological disorder.

22. The method of claim 20, wherein generating the computational network model for the disorder includes:
generating a normal computational network model of a portion of the human brain manifesting a plurality of normal characteristics of human behavior; and
introducing one or more physiological lesions to the normal computational network model consistent with suspected neuropathology of the disorder.

23. The method of claim 22, wherein introducing lesions comprises degrading neurons of the computational network model in a manner analogous to the degradation of neurons in humans afflicted with the disorder.

24. The method of claim 20, wherein applying the physiological data of the test compound comprises modeling effects of the test compound on neuronal ion channels.

25. The method of claim 24, wherein modeling the effects of the test compound comprises modeling the effects of the test compound on receptors.

26. The method of claim 20, wherein applying the physiological data of the test compound comprises modeling effects of the test compound on dendritic input integrating for producing an axonal output.

27. The method of claim 20, wherein applying the physiological data of the test compound comprises modeling the effects of the test compound on intracellular messaging.

28. The method of claim 20, wherein applying the physiological data of the test compound comprises affecting neurotransmitter release properties of neurons in the computational network model.

29. The method of claim 20, further comprising implementing experimental clinical data in the computational network model.

30. The method of claim 20, wherein determining the efficacy of the test compound for treatment includes determining whether the application of the test compound modifies behaviors attributable to the disorder in a beneficial way.

31. The method of claim 20, wherein the disorder is schizophrenia.

32. The method of claim 20, wherein the disorder is Alzheimer's disease.

33. The method of claim 20, wherein the disorder is dementia.

34. The method of claim 20, wherein the disorder is a seizure disease

35. The method of claim 1, wherein creating a computer model comprises
generating a first computational network model for the disorder; and
applying input data of a test compound to the first network model to obtain resulting data from the first network model;
and wherein the method further comprises
comparing resulting data from the first network model with resulting data from a second network model simulating exposure to a test compound known to be effective for treating the disorder; and
determining, based on the comparison between the resulting data of the first and second network models, the efficacy of the test compound for treatment of the disorder.

36. The method of claim 35, wherein the medical disorder is a neuropsychiatric or neurological disorder.

37. The method of claim 35, wherein generating the computational network model for the disorder includes:
generating a computational network model manifesting a plurality of normal characteristics of human behavior; and
introducing one or more physiological lesions to the normal computational network model consistent with suspected neuropathology of the disorder.

38. The method of claim 37, further comprising adding functional characteristics to generate a model of the disorder by degrading neurons of the computational network model in a manner analogous to the degradation of neurons in humans afflicted with the disorder.

39. The method of claim 35, wherein applying the physiological data of the test compound comprises modeling effects of the test compound on neuronal ion channels.

40. The method of claim 39, wherein modeling the effects of the test compound comprises simulating dopamine induced effects on the computational network model.

41. The method of claim 35, wherein applying the physiological data of the test compound comprises modeling effects of the test compound on dendritic input integrating for producing an axonal output.

42. The method of claim 35, wherein applying the physiological data of the test compound comprises altering how intracellular processes are performed in the computational network model.

43. The method of claim 35, wherein applying the physiological data of the test compound comprises affecting neurotransmitter release properties of neurons in the computational network model.

44. The method of claim 35, wherein determining the efficacy of the test compound for treatment includes determining whether the application of the test compound modifies behavior attributable to the disorder in a beneficial way.

45. The method of claim 36, wherein the disorder is schizophrenia.

46. The method of claim 36, wherein the disorder is Alzheimer's disease.

47. The method of claim 36, wherein the disorder is dementia.

48. The method of claim 36, wherein the disorder is a seizure disease.

49. A system for screening a test compound, the system comprising:
a processor;
a memory coupled to the processor, the memory encoding software that, when executed, causes the processor to:
generate a computational network model manifesting a neuropsychiatric or neurological disorder;
apply physiological data of the test compound to the computational network model; and
determine, based on the application of the physiological data to the network model of the neuropsychiatric or neurological disorder, the efficacy of the test compound for treatment of the disorder.

50. The system of claim 49, wherein the medical disorder is a neuropsychiatric or neurological disorder.

51. The system of claim 49, wherein the software further causes the processor to:
generate a computational network model manifesting a plurality of normal characteristics of human behavior; and
introduce physiological lesions to the normal computational network model consistent with suspected neuropathology of the neuropsychiatric or neurological disorder.

52. The system of claim 49, wherein the software further causes the processor to add functional characteristics to generate a model of the medical disorder by degrading neurons of the computational network model in a manner analogous to the degradation of neurons in humans afflicted with the disorder.

53. The system of claim 49, wherein the software causes the processor to apply the physiological data of the test compound by causing the processor to model effects of the test compound on neuronal ion channels.

54. A computer-readable medium having encoded thereon a data structure representative of a biologically-realistic model of a volume of hippocampal tissue, the data structure comprising:
data representative of population of neurons in each layer of the hippocampus;
data representative of types of neurons in each layer of the hippocampus; and
data representative of synaptic connections between neurons in the hippocampus.
